(19) United States
(12) Patent Application Publication
(10) Pub. No.: US 2014/0310527 A1
(43) Pub. Date: Oct. 16, 2014

(54) Secure Distribution of Content

(71) Applicants: Koninklijke KPN N.V., The Hague (NL); Nederlandse Organisatie voor Toegepast-Natuurwetenschappelijk Onderzoek TNO, Delft (NL)

(72) Inventors: Peter Joannes Mathias Veugen, The Hague (NL); Mattijs Oskar van Deventer, Leidschendam (NL)

(73) Assignees: KONINKLIJKE KPN N.V., The Hague (NL); Nederlandse Organisatie voor Toegepast-Natuurwetenschappelijk Onderzoek TNO, Delft (NL)

(21) Appl. No.: 14/351,678

(22) PCT Filed: Oct. 24, 2012
(86) PCT No.: PCT/EP2012/070995

§ 371 Date: Apr. 14, 2014

(30) Foreign Application Priority Data
Oct. 24, 2011 (EP) 11186388.2

(51) Int. Cl. H04L 9/08

(52) U.S. Cl. CPC H04L 9/085
USPC 713/171; 713/150

(57) ABSTRACT

Methods and systems are described for enabling secure delivery of a content item from a content source to a content receiving device associated with a decryption module configured for use with a split-key cryptosystem comprising encryption and decryption algorithms E and D, a cipher algorithm for generating encryption and decryption keys e,d on the basis of secret information S and a split-key algorithm for splitting e and/or d into i different split-encryption keys e₁, e₂, . . . , eᵢ and/or k different split-decryption keys d₁, d₂, . . . , dₖ respectively, such that Ddk(Ddk-₁( . . . (D_{d2}(D_{d1}(Eₑᵢ(Eₑᵢ₋₁( . . . (Eₑ₂(Eₑ₁(X)) . . . ))=D_{dk}(D_{dk-1}( . . . (D_{d2}(D_{d1}(X_{e1, e2, . . . , ei}))=X wherein i,k≧1 and i+k>2, wherein the method comprises: provisioning said decryption module with first split-key information comprising at least a first split-key; generating second split-key information comprising at least a second split-key on the basis of said first split-key information, said decryption key d and, optionally, said secret information S; and, provisioning said decryption module with said at least second split-key 1 information for decrypting an encrypted content item Xₑ on the basis of said first and second split-key information and decryption algorithm D in said decryption module.

### FIELD OF THE INVENTION

The invention relates to secure distribution of content and, in particular, though not exclusively, to methods and systems for secure distribution of content, a key generator, a decryption module and a recording medium for use in such system, and a computer program product using such method.

### BACKGROUND OF THE INVENTION

File-based and streaming content (e.g. movies and TV programs) have high cost and value associated with its creation and sales. For that reason a content provider may use content protection systems like Digital Rights Management (DRM) and Conditional Access (CA) systems in order to protect the content against unauthorized distribution and which only allow authorized users and systems to access it.

In a conventional DRM system, content distribution is achieved by a content provider distributing encrypted content, typically in the form of an electronic file, to a purchaser. A decryption key provided to the purchaser allows access to the content, wherein the use of the content may be restricted by an electronic licence. Hence, in such scheme, every transaction requires the generation of an encryption key and an associated decryption key, whereby every purchaser acquires its own personal encrypted copy of the content. Unauthorized publication of the decryption key only causes limited damage as other copies are encrypted differently. Such DRM systems however are less suitable for true mass-distribution systems such as broadcast or multicast streaming systems or content distribution network (CDN) systems. Implementing such known DRM system or method for use in a mass-distribution system like a CDN requires either additional processing power for supporting intensive content encryption capability on the edge nodes of a CDN and/or requires a CDN with enough transport capacity for allowing transmission of multiple differently encrypted copies of the same content item through the distribution network (in case the encryption is performed in some central node). Hence such conventional DRM solution would require complex modifications of existing CDN equipment, in particular on the edge nodes or it introduces extensive bandwidth requirements in the CDN.

In contrast, conventional broadcast conditional access (CA) systems, e.g. a DVB CA system, are configured for mass-distribution of content. In such CA system, content is encrypted (scrambled) using a symmetric encryption key (control word) and transmitted to a large group of subscribers. In order to allow a subscriber access to the content, the control words are encrypted and sent as so-called entitlement control messages (ECM) to a conditional access receiver of a subscriber. The receiver comprises a secure module, e.g. a smart card or the like, comprising a secret key in order to decrypt the ECM and to descramble the scrambled content into clear text content. In such schemes, unauthorized publication of a secret key originating from a compromised secure module is damaging as it enables others to access the broadcasted encrypted content.

Moreover, if the secure modules require pre-configuration with a secure key during the manufacturing or distribution of such secure modules, key information needs to be provided to a third-party, e.g. the manufacturer of the secure hardware module, which embeds the key information in such secure hardware module. Hence, a trusted relation between the content provider and third parties is required in order to entrust the key information to the third party. Providing such large amounts of key information to third parties is undesirable, because if during that process the key information is intercepted or corrupted, a large amount of hardware modules are rendered worthless.

Further problems may arise when content distribution is outsourced by the content provider to an intermediate party, a content distributor. In such case encrypted content originating from the content provider may have to be decrypted and re-encrypted by the content distributor before delivery to the consumer. Hence, when outsourcing the delivery of the content, a certain trusted relation between the content provider and the content distributor, such as a content delivery network (CDN), is needed such that the content provider can rely on the content distributor that the content is delivered in accordance with certain predetermined conditions, e.g. secure delivery, and that the content provider is correctly paid for each time that a consumer requests a particular content item from the content distributor.

The importance of a trusted relation between the content provider and the content distributor gets even more prominent if a content distributor may or, in certain circumstances, must outsource the delivery of a content item to a consumer via one or more further content distributors, e.g. via a network of interconnected CDNs. In such situations, the process of delivery and billing of content items to large groups of consumers may easily become a very complex and non-transparent process. Moreover, the more distributors between the content provider and the consumers, the larger the chance that the security may be compromised by unauthorized parties. A content distributor may use a content protection system for protecting the content against unauthorized access. If however the security system of the content distributor is compromised, then all stored and handled content may be potentially compromised.

Hence, methods and systems are desired for secure delivery of content which allow simple mass-distribution of encrypted content while at the same time allowing decryption of the content on the basis of key information which may be unique per individual user or group of users. Moreover, methods and systems are desired which allow secure delivery of content via one or more third parties without enabling the third-parties (content distributors) to access the content. Moreover, methods and systems are desired which allow a content distributor to control or at least monitor the secure delivery of content originating from a content provider, via a content distributor or a network of content distributors to a large group of consumer and to detect a security breach during said secure delivery of content to said consumers.

### SUMMARY OF THE INVENTION

It is an object of the invention to reduce or eliminate at least one of the drawbacks known in the prior art and to provide in a first aspect of the invention a method for enabling secure delivery of a content item from a content source to a content receiving device. The content receiving device is associated with a decryption module configured for use with a split-key cryptosystem. The split-key crypto system comprises encryption and decryption algorithms E and D, a cipher algorithm for generating encryption and decryption keys e,d on the basis of secret information S and a split-key algorithm using secret information S for splitting e into i different split-encryption keys e₁, e₂, . . . , eᵢ, and/or for splitting d into k different split-decryption keys d₁, d₂, . . . , dₖ respectively. The split-key cryptosystem is further defined in that executing a number of consecutive encryption and decryption operations on content item X, applying E and split-encryption keys e₁, e₂, . . . , eᵢ, and applying D and split-decryption keys d₁, d₂, . . . , dₖ respectively, conforms to D_{dk}(D_{dk-1}( . . . (D_{d2}(D_{d1}(Eₑᵢ(Eₑᵢ₋₁( . . . (Eₑ₂(Eₑ₁(X)) . . . ))=D_{dk}(D_{dk-1}( . . . (D_{d2}(D_{d1}(X_{e1, e2, . . . , ei}))=X wherein i,k≧1 and i+k>2. The above condition thus described, defines an intrinsic property of a split-key crypto system according to an aspect of the invention. Throughout the description different examples of split-key crypto systems and the algorithms used, are disclosed. The method according to an aspect of the invention makes advantageous use of this specific property of such a split-key crypto system.

The method according to an aspect of the invention comprises the steps of: provisioning said decryption module with first split-key information comprising at least a first split-key; generating second split-key information comprising at least a second split-key on the basis of said first split-key information, said decryption key d and, optionally, said secret information S; and, provisioning said decryption module with said at least second split-key information for decrypting an encrypted content item Xₑ on the basis of said first and second split-key information and decryption algorithm D in said decryption module.

The use of the split-key cryptosystem in secure content distribution provides a multitude of technical advantages. It allows the Content Source (also referred to a Content Provider; CP or CS) to be in full control of the distribution of the content. In an aspect of the invention the split-key cryptosystem only requires encryption of a content item once, using for example encryption algorithm E and using encryption key e. Every secure (decryption) module may be (pre-)provisioned with a different first split-key (e.g. a different first split-decryption key d₁) and every transaction associated with a secure (decryption) module or a group of secure modules may include the generation (and subsequent provisioning to the secure (decryption) module) of at least a second split-key (e.g. a different second split-decryption key d₂), which is unique for the content and the secure module. The secure (decryption) module may subsequently execute two consecutive decryption operations using decryption algorithm D and using spit decryption keys d₁ and d₂ respectively. This way, content items do not need to be decrypted and/or separately (re)encrypted for different users thereby allowing true mass-delivery, e.g. broadcast, to a large number of secure modules. Furthermore, if a split-key provisioned secure module gets compromised, it does not affect the security of delivery of a content item to another Content Consumption Unit (also referred to as CCU)s associated with (either comprising or communicatively connected to) another secure module. Neither does it affect the security of the split-key cryptosystem as a whole. Similarly, interception of a single split-key generated upon a transaction does not affect the security of the other CCUs or the system as a whole, since this key may only be used by a specific CCU and content item.

In one embodiment said content source may be associated with an encryption module comprising at least one encryption algorithm E; and, a secret key generator, said secret key generator comprising said cipher algorithm and split-key algorithm for generating encryption key information for decrypting a content item and said at least first and second split-key information respectively.

In other words the encryption module may be part of the content source or it is able to communicate with content source through a network connection (wired or wireless).

In an embodiment a split-key may refer to a split-decryption key d₁-dₖ.

In a further embodiment a split-key may refer to a split-encryption key e₁-eᵢ.

In an embodiment said method may comprise: said encryption module receiving encryption information from said secret key generator; said encryption module generating at least one encrypted content item Xₑ on the basis of said encryption key information.

In an embodiment said decryption module may be provisioned with said first and second split-key information using different split-key information provisioning methods or wherein said decryption module is provisioned with said first and second split-key information at a first point in time and a second point in time respectively, preferably said first point in time being the time wherein said decryption module is manufactured, sold or distributed to a user or registered and preferably said second point in time being the time that said content receiving device transmits a content request to said content source.

In an embodiment provisioning said first split-key information includes providing said first split-key information in said decryption module, preferably in a secure hardware module in said (secure) decryption module, during the manufacturing, distribution, activation or registration of said decryption module.

In an embodiment provisioning said first split-key information may include: establishing a secure channel between said content source and said decryption module; and, sending said at least first split-key information via said secure channel to said decryption module, preferably said secure channel being established during an authentication or registration process of said content receiving device to said content source.

In an embodiment provisioning said first split-key information may include: embedding said at least first split-key information in a secure hardware module, preferably a smart card comprising said decryption module;

In an embodiment provisioning said first split-key information may include: instructing a first split-key generator in said decryption module for generating first split-key information, preferably said first split-key generator being instructed by a signaling message originating from said content source or by a common signaling message common to said content source and said decryption module, preferably said common signaling message including a time associated with a clock which is shared between said content source and said decryption module.

In an embodiment provisioning said second split-key information includes transmitting said second split-key information, preferably over a secure channel, to said decryption module or recording said at least second split-key information on a recording medium.

In an embodiment said content source may be a content transmitting system or a content recording apparatus for recording encrypted content into a recording medium.

In an embodiment said method may comprise: said decryption module receiving said encrypted content item;

decrypting at least part of said encrypted content item on the basis of said at least said first split-key information into a partially decrypted content item; and, decrypting said partially decrypted content item into a plaintext content item on the basis of said at least second split-key information. In an embodiment said encrypted content item may be received in response to a content request.

In an embodiment said method may comprise: providing an at least one content delivery network (CDN) or a network of CDNs with at least one encrypted content item; on the basis of said first and second split-key information, said decryption key d and, optionally said secret information S, generating third split-key information; provisioning at least one decryption module associated with said CDN or network of CDNs with said third split-key information; generating a partially decrypted content item on the basis of said encrypted content item, a decryption algorithm D in said CDN and said third-split key information; and, transmitting said partially decrypted content item to said content receiving device. Hence, in this embodiment security is improved as each content item is uniquely encrypted for each CDN in a network of CDNs.

In an embodiment said at least first split-key information may comprise a plurality of first split-keys (e.g. first split-decryption keys) and first split-key identifiers, preferably said plurality of first split-keys comprising one or more geography-specific split-keys which are valid for a particular geographical area, hardware-specific split-keys which are valid for a particular hardware device or group of hardware device, content-specific split-keys which are valid for predetermined content item or group of content items and/or user-specific split-keys which are valid for a particular user or group of users.

In an embodiment said method may comprise: providing said decryption module with information for selecting of one more split-keys, preferably said information comprising one or more first key identifiers; selecting one or more first split-keys from said plurality of first split-keys, preferably on the basis of said one or more first key identifiers.

In an embodiment said method may comprise: combining two or more of said first split-keys into a first combined split-key; and, using said first combined split-key as first-split key information.

In an embodiment said split-key algorithm may comprise a random split-key generating algorithm for generating first split-key information and a further split-key generating algorithm for generating second split-key information on the basis of said first split-key information.

In an embodiment said first split-key generator in said content receiving device may comprise a pseudo random generator, said method comprising: said split-key generator receiving information for generating a seed for said pseudo random generator; generating a pseudo random value; checking whether said pseudo random value complies with one or more conditions imposed by said split-key cryptosystem.

In an embodiment said content source may be associated with a secret key generator comprising a second split-key generator which is substantially identical to said first split-key generator in said decryption module, wherein the method may comprise: providing information for generating a seed to said first and second split-key generators; said first and second split-key generators generating second split-key information; said secret key generator determining first split-key information on the basis of said secret information S and said second split-key information; and, providing said first split-key information to said decryption module associated with said content receiving device.

In an embodiment said cipher algorithm, also generally referred to as a key generation algorithm, is based on at least one of the one-time path, LFSR stream cipher, RSA, EIGamal and/or Damgard-Jurik cryptosystems (also referred to as crypto schemes). The cipher algorithm (key generation algorithm) is specific for the used (split-key) cryptosystem. In addition to that the split-key algorithm is also specific for the used cryptosystem and forms together with the crypto system a split-key cryptosystem. The term ‘specific’ indicates that such algorithms cannot be randomly used in combination with any cryptosystem, or encryption-decryption algorithm pair. Only certain combinations will form a split-key cryptosystem with the properties as defined in this application. Certain split-key cryptosystems may have additional properties (advantages) over others.

For example a split-key RSA cryptosystem has the additional advantage that RSA keys cannot be split without secret information φ(n). This way, it is assured that no unauthorized party is able to split keys provided by the SKG. This will prevent so-called man-in-the-middle attacks wherein a man-in-the-middle intercepts a key provided by the SKG and combines it with his own secret key. Furthermore, this also allows provisioning of second split-key information to the CCU without the use of a secure channel.

Thus, in one embodiment, when using a split-key RSA cryptosystem according to the invention, second split-key information may be provisioned to the CCU via a non-secured channel e.g. broadcast or multicast. Alternatively, second split-key information may be stored together with encrypted content on an optical or magnetically storage medium wherein the split-key is stored in an unprotected storage area of the DVD.

In an embodiment said content receiving device is part of: a media player, a set-top box, a content recorder, a apparatus for reading a storage medium, preferably an optical, magnetic and/or semiconductor storage medium.

In a further aspect the invention may relate to a method for enabling secure delivery of key information from at least first secure module associated with a content source device, preferably a content transmitting device or a content recording apparatus for recording encrypted content onto a recording medium, to at least a second secure module in a content receiving device using a split-key cryptosystem comprising encryption and decryption algorithms E and D, a cipher algorithm for generating encryption and decryption keys e,d on the basis of secret information S and a split-key algorithm using secret information S for splitting e into i different split-encryption keys e₁, e₂, . . . , eᵢ and/or for splitting d into k different split-decryption keys d₁, d₂, . . . , dₖ respectively; The split-key cryptosystem is further defined in that executing a number of consecutive encryption and decryption operations on content item X, applying E and split-encryption keys e₁, e₂, . . . , eᵢ, and applying D and split-decryption keys d₁, d₂, . . . , dₖ respectively, conforms to; D_{dk}(D_{dk-1}( . . . (D_{d2}(D_{d1}(Eₑᵢ(Eₑᵢ₋₁( . . . (Ee₂(Eₑᵢ(X)) . . . ))=D_{dk}(D_{dk-1}( . . . (D_{d2}(D_{d1}(X_{e1, e2, . . . , ei}))=X wherein i,k≧1 and i+k>2, wherein the method may comprise: provisioning said second secure module with at least first split-key information; said first secure module generating encrypted key Eₑ(K) on the basis of encryption algorithm E and at least one encryption key e, wherein K is a key for encrypting content to be transmitted by said content transmitting device; a key generator comprising said cipher algorithm and split-key algorithm generating second split-key information on the basis of said first split-key information, said decryption key d and said secret information S and transmitting said second split-key information to said second secure module; said second secure module applying a decryption operation on said encrypted key D_{d1}(Eₑ(k)) on the basis of said second split-key information and said decryption algorithm.

This embodiment allows hybrid encryption combining efficient symmetric encryption of content item X and secure asymmetric encryption of symmetric encryption key kx using a split-key cryptosystem. In case of streaming media, the symmetric encryption key (or secret seed) kx could be changed in time on a regular basis (key roll-over).

In a further aspect, the invention may relate to a method for secure delivery of a content item from a content source via at least first and second content distribution networks (CDN1,CDN2) to at least one content receiving device associated with a decryption module using a split-key cryptosystem comprising encryption and decryption algorithms E and D, a cipher algorithm for generating encryption and decryption keys e,d on the basis of secret information S and a split-key algorithm using secret information S for splitting e into i different split-encryption keys e₁, e₂, . . . , eᵢ and/or for splitting d into k different split-decryption keys d₁, d₂, . . . , dₖ respectively; The split-key cryptosystem is further defined in that executing a number of consecutive encryption and decryption operations on content item X, applying E and split-encryption keys e₁, e₂, . . . , eᵢ, and applying D and split-decryption keys d₁, d₂, . . . , dₖ respectively, conforms to D_{dk}(D_{dk-1}( . . . (D_{d2}(D_{d1}(Eₑᵢ(Eₑᵢ₋₁( . . . (Eₑ₂(Eₑᵢ(X)) . . . ))=D_{dk}(D_{dk-1}( . . . (D_{d2}(D_{d1}(X_{e1, e2, . . . , ei}))=X wherein i,k≧1 and i+k>2, wherein the method may comprise: provisioning said decryption module with at least first split-key information; providing said first CDN1 with at least one encrypted content item Xₑ or a partially decrypted content item; said first CDN1 transmitting said at least one encrypted content item or a partially decrypted content item to said second CDN2; a key generator comprising said cipher and split-key algorithm generating second and third split-key information associated with said at least one encrypted content item Xₑ or a partially decrypted content on the basis of said first split-key information, said encryption key d and, optionally, said secret information S; transmitting a first split-decryption control message comprising said second split-key information to said first CDN1 and a second split-decryption control message comprising third split-key information to said encryption module; said first CDN1 relaying said first split-decryption control message to said second CDN2; generating a partially decrypted content item or further partially decrypted content item by applying a decryption operation on said encrypted content item or said partially decrypted content item using said decryption algorithm D and said second split-key information; and, transmitting said partially decrypted content item or further partially decrypted content item to said decryption module for decrypting of said partially decrypted content item or further partially decrypted content item into a plaintext content item on the basis of said first and third split-key information and decryption algorithm D in said decryption module.

Hence, in this embodiment, CDN1 screens all downstream CDNs (CDN2) from the content source. This way, the CS, and in particular the secret key generator associated with the CPS, only needs to have an interface with CDN1 and CCUs. The CS only interacts with CDN1 and CDN1 outsources delivery of a content item by transparently forwarding encrypted content and a request routing message comprising the split-key information to CDN2. Furthermore, the system allows transparent delivery of a content item through the CDN network. At varies stages of the delivery process, the CS is informed and asked to take a certain action, e.g. generation and/or delivery of certain (split-)keys.

In another aspect the invention may relate to a system for enabling secure delivery of a content item X from a content source to a content receiving device said system being configured for use with a split-key cryptosystem comprising encryption and decryption algorithms E and D, a cipher algorithm for generating encryption and decryption keys e,d on the basis of secret information S and a split-key algorithm for splitting e into i different split-encryption keys e₁, e₂, . . . , eᵢ and/or for splitting d into k different split-decryption keys d₁, d₂, . . . , dₖ respectively; The split-key cryptosystem is further defined in that executing a number of consecutive encryption and decryption operations on content item X, applying E and split-encryption keys e₁, e₂, . . . , eᵢ, and applying D and split-decryption keys d₁, d₂, . . . , dₖ respectively, conforms to D_{dk}(D_{dk-1}( . . . (D_{d2}(D_{d1}(Eₑᵢ(Eₑᵢ₋₁( . . . (Eₑ₂(Eₑᵢ(X)) . . . ))=D_{dk}(D_{dk-1}( . . . (D_{d2}(D_{d1}(X_{e1, e2, . . . , ei}))=X wherein i,k≧1 and i+k>2, wherein said system may comprise: an encryption module associated with a content source, said encryption module comprising said encryption algorithm E for generating an encrypted content item Xₑ; a key generator associated with said encryption module comprising said cipher algorithm and said split-key algorithm; and, a decryption module associated with said content receiving device configured for decrypting an encrypted content item on the basis of at least first and second split-key information and said decryption algorithm D.

In yet another aspect, the invention may relate to a key generator for use in a system as described above. The key generating system may comprise: a cipher generator for generating a decryption key d and encryption key e on the basis of secret information S; a split-key generator comprising a random generator for generating at least i−1 different random split-encryption keys e₁, e₂, . . . , eᵢ₋₁ and/or at least k−1 different split-decryption keys d₁, d₂, . . . , dₖ₋₁ respectively, on the basis of said secret information S and a further split-key algorithm for determining a further split-encryption key ei or further split-decryption key dₖ, said split-keys being used in a split-key cryptosystem comprising encryption and decryption algorithms E and D; The split-key cryptosystem is further defined in that executing a number of consecutive encryption and decryption operations on content item X, applying E and split-encryption keys e₁, e₂, . . . , eᵢ, and applying D and split-decryption keys d₁, d₂, . . . , dₖ respectively, conforms to D_{dk}(D_{dk-1}( . . . (D_{d2}(D_{d1}(Eₑᵢ(Eₑᵢ₋₁( . . . (Eₑ₂(Eₑᵢ(X)) . . . ))=D_{dk}(D_{dk-1}( . . . (D_{d2}(D_{d1}(X_{e1, e2, . . . , ei}))=X wherein i,k≧1 and i+k>2.

In an embodiment said encryption and decryption algorithms E,D and said cipher algorithm are based on the ElGamal algorithm (scheme) and wherein said split-key algorithm for generating k split-keys may be defined as:
said random generator is configured to select k−1 random integers d₁ . . . dₖ₋₁ smaller than p;
compute final integer as dₖ=d−(d₁+ . . . +dₖ₋₁)(mod p).
   or, wherein said encryption and decryption algorithms are based on the Damgard-Jurik scheme E,D and wherein said split-key algorithm for generating k split-keys may be defined as:
determine n−1 random integers d1, . . . , dₙ₋₁ smaller than n compute dₖ=d−(d₁+ . . . +dₙ₋₁)(mod n).
   or, wherein said encryption and decryption algorithms E,D are based the one-time pad scheme and wherein said split-key algorithm for generating k split-keys may be defined as:
determine k−1 random binary streams d₁ . . . dₖ₋₁
compute dₖ=d₁⊕ . . . ⊕dₖ₋₁⊕e.
   or, wherein said encryption and decryption algorithms E,D are based on the RSA scheme and wherein said split-key algorithm for generating k split-keys is defined as:
determine k−1 random integers d₁, . . . , dₖ₋₁ which are coprime with φ(n)
compute dₖ=(d₁* . . . *dₖ₋₁)⁻¹*d(mod φ(n)).

In yet a further aspect, the invention may relate to a decryption module for use in a content receiving device (preferably a content consumption unit), said decryption module being configured for use in a split-key cryptosystem comprising encryption and decryption algorithms E and D, a cipher algorithm for generating encryption and decryption keys e,d on the basis of secret information S and a split-key algorithm using secret information S for splitting e into i different split-encryption keys e₁, e₂, . . . , eᵢ and/or for splitting d into k different split-decryption keys d₁, d₂, . . . , dₖ respectively; The split-key cryptosystem is further defined in that executing a number of consecutive encryption and decryption operations on content item X, applying E and split-encryption keys e₁, e₂, . . . , eᵢ, and applying D and split-decryption keys d₁, d₂, . . . , dₖ respectively, conforms to D_{dk}(D_{dk-1}( . . . (D_{d2}(D_{d1}(Eₑᵢ(Eₑᵢ₋₁( . . . (Eₑ₂(Eₑᵢ(X)) . . . ))=D_{dk}(D_{dk-1}( . . . (D_{d2}(D_{d1}(X_{e1, e2, . . . , ei}))=X wherein i,k≧1 and i+k>2, wherein said decryption module may comprise: an input for receiving encrypted content, said content being encrypted using at least one encryption key and encryption algorithm E; a secure storage for storing provisioned first split-key information; an input for being provisioned with second split-key information; and, at least one processor for executing at least a first decryption operation using said second split-key information and decryption algorithm D and for executing at least a second decryption operation using said provisioned first split-key information and decryption algorithm D.

In one aspect, the invention may relate to a recording medium comprising a recording area comprising data associated with a content item which is encrypted using encryption algorithm E and at least an encryption key or split-encryption key and a recording area comprising data associated with at least one split-decryption key for partially decrypting said encrypted content item using decryption algorithm D, said encryption and decryption algorithm E,D and said at least one split-key being part of a split-key cryptosystem comprising encryption and decryption algorithms E and D, a cipher algorithm for generating encryption and decryption keys e,d on the basis of secret information S and a split-key algorithm using secret information S for splitting e into i different split-encryption keys e₁, e₂, . . . , eᵢ and/or for splitting d into k different split-decryption keys d₁, d₂, . . . , dₖ respectively; The split-key cryptosystem is further defined in that executing a number of consecutive encryption and decryption operations on content item X, applying E and split-encryption keys e₁, e₂, . . . , eᵢ, and applying D and split-decryption keys d₁, d₂, . . . , dₖ respectively, conforms to D_{dk}(D_{dk-1}( . . . (D_{d2}(D_{d1}(Eₑᵢ(Eₑᵢ₋₁( . . . (Eₑ₂(Eₑᵢ(X)) . . . ))=D_{dk}(D_{dk-1}( . . . (D_{d2}(D_{d1}(X_{e1, e2, . . . , ei}))=X wherein i,k≧1 and i+k>2. Depending on the split-key algorithm used, the recording area comprising data associated with at least one split-decryption key may be a secure recording area or an unsecure recording area.

In another aspect the invention may relate to a content reproduction device comprising a decryption module as described above, wherein said content reproduction device may be configured to reproduce at least part of an content item and a split-key recorded on a recording medium as described above. The invention may also relate to a computer program product comprising software code portions configured for, when run in the memory of computer executing at least one of the method steps as described above.

The invention will be further illustrated with reference to the attached drawings, which schematically will show embodiments according to the invention. It will be understood that the invention is not in any way restricted to these specific embodiments.

### BRIEF DESCRIPTION OF THE DRAWINGS

FIGS. 1 (A) and (B) depict a split-key cryptosystem for secure distribution of content according to an embodiment of the invention.

FIG. 2 depicts a schematic of a secret key generator according to one embodiment of the invention.

FIGS. 3(A) and (B) depict stream ciphers for use in a split-key cryptosystem according to various embodiments of the invention.

FIG. 4 depicts flow charts illustrating the generation of the encryption/decryption pair e,d and associated split-keys according to various embodiments of the invention.

FIGS. 5 (A) and (B) depict a split-key cryptosystem for secure distribution of content according to another embodiment of the invention.

FIGS. 6 (A) and (B) depict a split-key cryptosystem for secure distribution of content according to yet another embodiment of the invention.

FIG. 7 depicts a schematic of a secure content delivery system for delivering content to a content consumption unit according to an embodiment of the invention.

FIG. 8 depicts a schematic of protocol flow of a content delivery system using a split-key cryptosystem according to one embodiment of the invention.

FIG. 9 depicts a schematic of protocol flow of a content delivery system using a split-key cryptosystem according to another embodiment of the invention.

FIG. 10 depicts a conventional multi-layered encryption scheme.

FIGS. 11 (A)-(C) depict various implementations of a split-key cryptosystem in a multi-layered encryption scheme.

FIG. 12 depicts a hybrid split-key cryptosystem according to an embodiment of the invention.

FIG. 13 depicts a split-key cryptosystem for secure distribution of content according to a further embodiment of the invention.

FIG. 14 depicts a schematic of protocol flow of a content delivery system using a split-key cryptosystem according to yet another embodiment of the invention.

FIG. 15 depicts a split-key cryptosystem for secure distribution of content according to a yet further embodiment of the invention.

FIG. 16 depicts a split-key cryptosystem for secure distribution of content according to an embodiment of the invention.

FIG. 17 depicts a split-key cryptosystem for secure distribution of content according to another embodiment of the invention.

FIG. 18 depicts a protocol flow associated with a secure content distribution system according to an embodiment of the invention.

FIG. 19 depicts a protocol flow associated with a secure content distribution system according to an embodiment of the invention.

FIGS. 20 (A) and (B) depict schematics of a secure content distribution system according to another embodiment of the invention.

FIG. 21 depicts a schematic of a protocol flow of a content delivery system using a split-key cryptosystem according to an embodiment of the invention.

### DETAILED DESCRIPTION

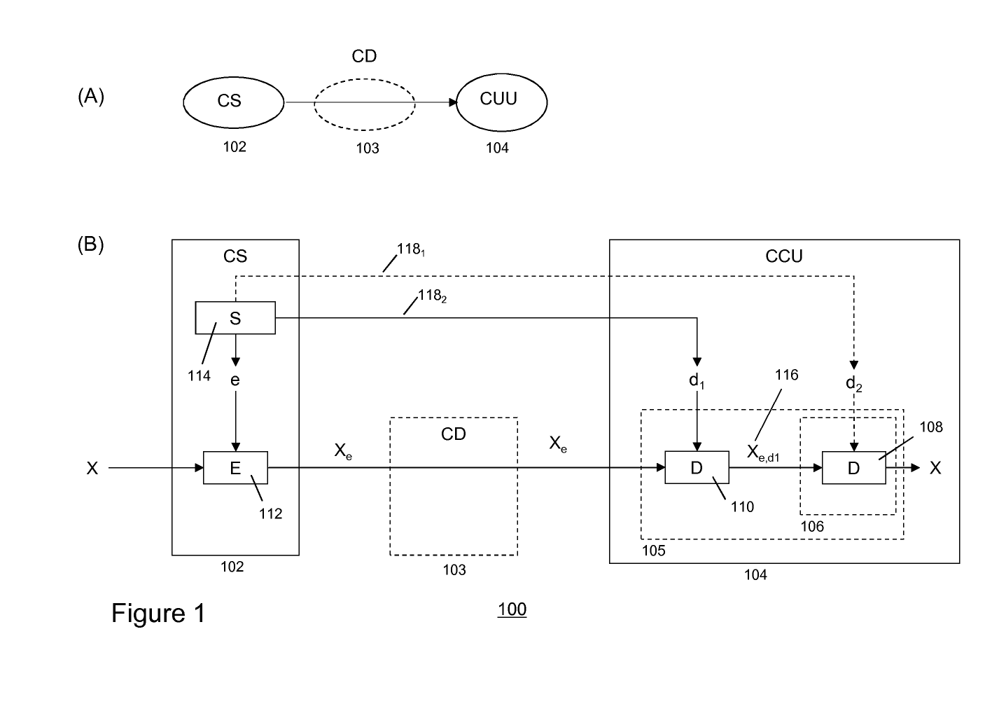

FIG. 1 (A) depicts a high-level schematic of a content distribution system. The system may generally comprise a content source (CS) 102, e.g. a content provider system (CPS) or a content processing system configured to receive (plaintext) content from a content provider system, to one or more content consumption units (CCU) 104.

The content provider system may use a content distributor or a chain of different content distributors 103 configured to distribute content from the content source to the content consumption units. A content distribution platform may use electronic means for delivering content. For example, in one embodiment one or more content delivery networks (CDNs). Alternatively, it may use physical means for delivering content on a recording medium, e.g. a magnetic recoding medium, an optical recoding medium using e.g. DVD and Blu-Ray technology, an opto-magnetic recording medium and/or solid-state recording media.

The CS may be configured to offer and/or deliver content items, e.g. video, pictures, software, data and/or text in the form of files and/or streams, including segmented files and/or streams (e.g. HAS-type files and/or streams), to customers or another content distributor. A consumer may purchase and receive the content items using a content consumption unit (CCU), comprising a software client for interfacing with the CDN and the CPS.

A CUU may generally relate to a device configured to process file-based and/or (live) streaming content. Such devices may include a (mobile) content play-out device such as an electronic tablet, a smart-phone, a notebook, a media player, a player for play-out of a recording medium such as a DVD of a Blu-Ray player. In some embodiments, a CCU may be a set-top box or a content recording and storage device configured for processing and temporarily storing content for future consumption by a further content consumption unit.

In the content delivery system described with reference to FIG. 1(A) it is desired that content is securely delivered to a large number of CCUs and that billing and payments are efficiently processed.

The content therefore requires protection by a content protection system, which may be implemented such that when content delivery is initiated by e.g. a consumer purchasing a content item, encrypted content is delivered to the CCU of the consumer. Access to the encrypted content is granted by information, which allows decryption of the encrypted content at the CCU.

As will be described hereunder in more detail, the content protection system according to the present invention allows a content source (sometimes also referred to as a content originator) to be in full control of the secure delivery of the content even though the actual delivery of the content is outsourced to one or more content distributors. In order to achieve this, the content protection system uses a so-called split-key cryptosystem. The details and advantages this cryptosystem are described hereunder in more detail with reference to the appending figures.

FIG. 1 (B) depicts a split-key cryptosystem for distributing content originating from a CS 102 to one or more content consumption units CCU 104 according to an embodiment of the invention. The CS may be associated with an encryption module 112 comprising an encryption algorithm E, and secret key generator 114 for generating keys on the basis of secret information S. The CCU may comprise a decryption module DM 105, i.e. a processor for executing a decryption algorithm D. In one embodiment, the decryption module may be configured to execute at least a first split-decryption operation 108 using decryption algorithm D and first split-key information comprising at least a first split-(decryption) key d₂ and a second split-key operation 110 using decryption algorithm D and second split-key information comprising at least a second split-(decryption) key d₁. Preferably decryption module is implemented as a secure module, e.g. a smart card, (U)SIM or other suitable hardware-secured processor. Secret key generator (SKG) 114, which may be implemented as part of the CPS or as a separate key server, may generate encryption keys and so-called split-keys.

The split-key cryptosystem may be configured to provide secure delivery of a content item X to the CCU on the basis of the encryption and decryption algorithms E and D and the key information generated by the secret key generator. To that end, encryption algorithm E may use an encryption key e to encrypt content item X into encrypted content item Xₑ=Eₑ(X) wherein encryption key e is generated by secret key generator 114 (here Xₑ is a short notation of Eₑ(X), i.e. the application of encryption algorithm E to content item X using encryption key e).

The encrypted content may be electronically sent as an encrypted file or stream to the CCU. Suitable protocols for electronic transmission include streaming protocols e.g. DVB-T, DVB-H, RTP, HTTP (HAS) or UDP/RTP over IP-Multicast. In an embodiment an adaptive streaming protocol such as HTTP adaptive streaming (HAS), DVB adaptive streaming, DTG adaptive streaming, MPEG DASH, ATIS adaptive streaming, IETF HTTP Live streaming and related protocols may be used. The content may be transported in a suitable transport container of a particular format such as AVI or MPEG.

Alternatively, the encrypted content may be recorded on a storage medium, e.g. an optical storage medium such as the Blu-Ray disc, a solid-state storage medium or a magnetic storage medium, which may be delivered to the user of the CCU.

As can be seen from FIG. 1(B) secret key generator may generate split-key information 118_{1,2}, including split-decryption keys d₁ and d₂. In one embodiment, the different split-keys may be provisioned to the decryption module using different provisioning processes. Furthermore, in another embodiment, the provisioning of the different split-keys may be initiated at different points in time.

For example, in a first embodiment, a first split-key d₂ may be pre-configured in the decryption module. Here pre-configuration may include storing or embedding split-key d₂ in a secure hardware unit 106, which may be part of the decryption module. The secure hardware unit may be designed as a tamper-free hardware module, which is not or at least very difficult to reverse engineer. Secure hardware units may include flash memory including OTP (one-time programmable) memory technologies in order to render physically secured key storage modules.

In one embodiment, the secure hardware unit may be part of a Trusted Platform Module (TPM) as specified the Trusted Computing Group. Reference is made to the TPM specification as laid down in international standard ISO/IEC 11889. In that case, the secure hardware unit may be provisioned with at least a split-key upon start-up or initialization of the CCU. During start-up the TPM may establish a secure connection with the secret key generator, which is configured to send split-key information to the decryption module.

In another embodiment, the decryption module may be provisioned with split-keys in an off-line process. For example, part of an (U)SIM or a smart card comprising the decryption module may be preconfigured with one or more split-keys during fabrication, during distribution or during activation or registration of the secure hardware modules. For example, during the purchase of a secure hardware module, the module may be configured with one or more split-keys.

In yet another embodiment, the decryption module may be provisioned with one or more split-keys using a secure channel associated with a registration and/or authentication procedure with the network. For example, split-keys may be retrieved during the authentication and/or registration processes associated with the CCU and subsequently stored in a secure memory of the decryption module. For example when using a mobile CCU, split-keys may be provisioned during the execution of an authentication and key agreement (AKA) associated with a mobile standard.

The secure hardware module may be further provisioned with second further split-key information. Preferably, the provisioning process associated with the second split-key information is different from the provisioning process associated with the first split-key information. Alternatively, the secure hardware module is provisioned with first and second split-key information at different moments in time using the same or a similar provisioning method.

For example, in one embodiment second split-key information may be delivered to the decryption module in the CCU via a secure channel, e.g. SSL or S-HTTP connection upon purchasing a content item. In more detail, the CCU may comprise a client configured to receive at least one encrypted content item and said at least second split-key information electronically via a secure channel. In another embodiment, the CPS may distribute encrypted content and the at least one split-key on a recording medium to the CCU. For example, the encrypted content may be recorded on an optical or magnetically storage medium wherein the split-key is stored in a secret storage area of the DVD.

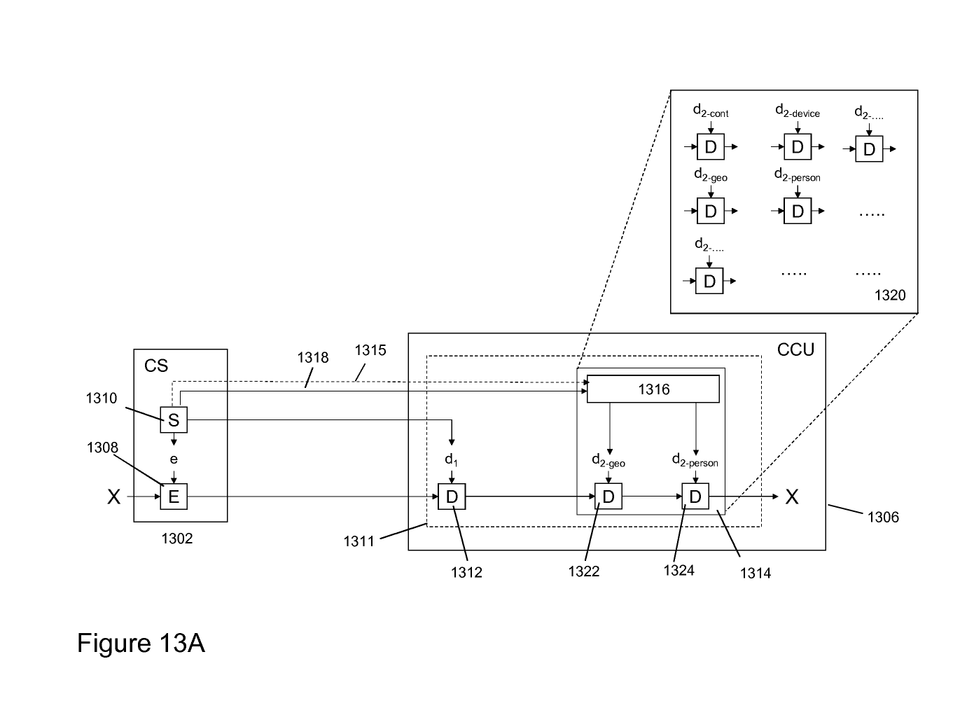

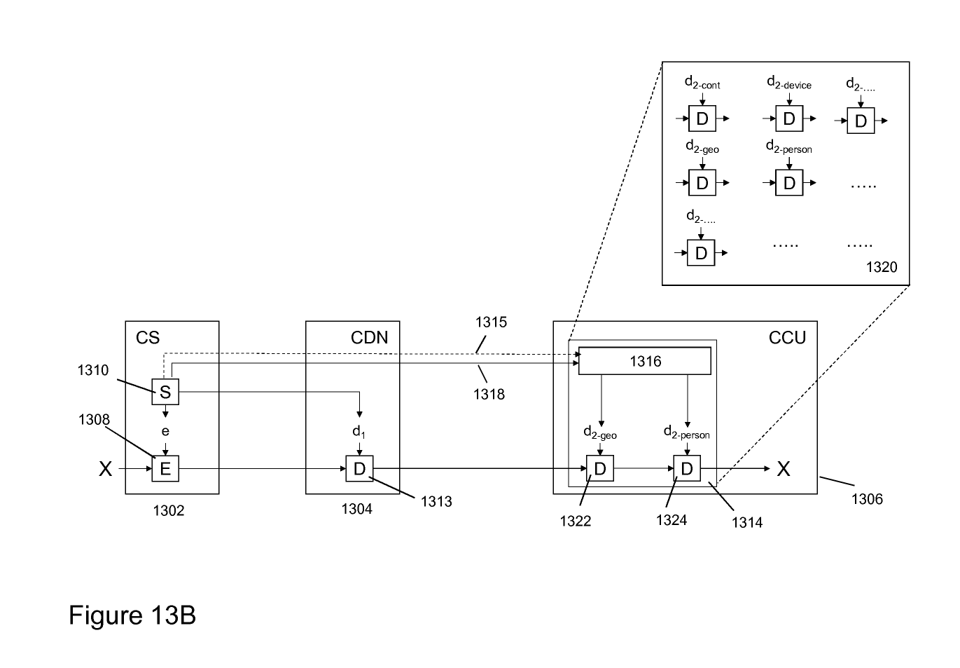

It is noted that the decryption module in the CCU may also comprise a split-key function, e.g. an (indexed) table comprising split-key information from which split-keys may be selected or a predetermined split-key generator. In that case, instead of a split-key, the CPS may send split-key identification information, e.g. a table index, a seed and/or some other identifier(s), to the split-key function in order the CCU to select or—in case of a (pseudo-random generator) generate one or more split-keys which are also known to the CPS. Examples of such split-key cryptosystems are described in more detail with reference to FIG. 13-15 and FIG. 20-21.

The split-keys are necessary to fully decrypt the encrypted content item Xₑ. Hence, as described above, split-decryption key d₂ 118₂ may be generated by the key generator and provisioned to the CCU. Then, if a user of a CCU requests delivery of content item X, the CPS may provision the CCU with a further split-decryption key d₁ 118₁ to the secure module in the CCU. When delivering encrypted content item to the user (either electronically or using a physical storage medium) first decryption module 110 may use split-decryption key d₁ and decryption algorithm D to “partially” decrypt encrypted content item into X_{e,d1} 116.

The thus “partially” decrypted content item X_{e,d1} may fully decrypt content item X by second decryption module on the basis of split-decryption key d₂ and decryption algorithm D such that D_{d2}(D_{d1}(Eₑ(X))=D_{d2}(D_{d1}(Xₑ))=D_{d2}(X_{e,d1})=X. Here, X_{e,d1} is a short notation of a decryption operation on encrypted content item Xₑ using decryption algorithm D and split-decryption key d₁. Note that the word “partially” (or “partly”) in this document refers to the process of encryption/decryption and not to the content. Moreover, partially decrypted content X_{e,d1} is cipher text and as such as secure to unauthorized access as fully encrypted content Xₑ.

The split-key cryptosystem as described in this document requires that the combined knowledge of Eₑ(X) and d₁ does not leak information about X. Furthermore, in some embodiments, it may also be required that the combined knowledge of Eₑ(X) and d₂ does not leak information about X. Moreover—particular in the context of CDNs—the split-key cryptosystem will be configured such that it allows the generation of many different split-key pairs d₁,d₂ on the basis of one encryption key e (so that each content consumer may obtain a different (personalized) set of keys for fully decrypting the encrypted content) and that the combined knowledge of Eₑ(X) with the many different split decryption key d₁ does not leak information about X and (in some embodiments) the combined knowledge of Eₑ(X) with the many different split decryption key d₂ does not leak information about X.

Hence, the secure content distribution system using a split-key cryptosystem as described with reference to FIG. 1(B) provides the technical advantage that the CS is in full control of the distribution of the content. The CS knows that a content item may only be played at a CCU comprising the pre-configured split-key d₂ and not on unauthorized devices, thus offering protection against further spread of decrypted content to other CCU. Further, the content item may only be played by a consumer having a CCU provisioned with split-key d₁. This allows protection against consumers who want to view more content items than paid for.

The split-key cryptosystem only requires encryption of a content item once using an encryption key. Every secure module may be provisioned with a different first split-key and every transaction associated with a secure module or a group of secure module may include the generation of at least a second split-key, which is unique for the content and the secure module. This way, content items do not need to be separately (re)encrypted for different users thereby allowing true mass-delivery, e.g. broadcast, to a large number of secure modules. Furthermore, if the split-key provisioned secure module gets compromised, it does not affect the other security of the other CCUs or the cryptosystem as a whole. Similarly, interception of a single split-key generated upon a transaction does not affect the security of the other CCUs or the system as a whole as this key may only be used by a specific CCU and content item.

As will be described hereunder in more detail, split-key cryptosystem allows the generation that the actual generation of the encryption key e and the further split-key d₁ may be proponed to a later stage, e.g. when the consumer actually requests a content item.

The split-crypto system depicted in FIG. 1(B) is just one non-limiting example of several groups of split-key cryptosystems, wherein each split-key cryptosystem is defined by at least a pair of encryption and decryption algorithms E,D, a cipher algorithm for generating encryption and decryption keys e,d on the basis of secret information S and a split-key algorithm for splitting e and/or d into multiple split-encryption and/or split-decryption keys respectively.

One group of split-key cryptosystems may be defined by crypto-algorithms E and D, a cipher algorithm for generating encryption and decryption keys e,d on the basis of secret information S and a split-key algorithm for multiple splitting of decryption key d into an arbitrary number of k split-decryption keys d₁, d₂, . . . , dₖ (k≧2) such that D_{dk}(D_{dk-1}( . . . (D_{d2}(D_{d1}(Eₑ(X)) . . . ))=D_{dk}(D_{dk-1}( . . . (D_{d2}(X_{e,d1}) . . . ))=X. Here X_{e, d1, d2, . . . , dk} is a short notation of a predetermined sequence of decryption operations on encrypted content item Xₑ using decryption algorithm D and split-decryption keys d₁, d₂, . . . , dₖ, respectively.

Another group of split-key cryptosystems may be defined by crypto-algorithms E and D, a cipher algorithm for generating encryption and decryption keys e,d on the basis of secret information S and a split-key algorithm for multiple splitting of e into an arbitrary number of i split-encryption keys e₁, e₂, . . . , eᵢ (i>2) such that D_{d}(Eₑᵢ(Eₑᵢ₋₁ . . . (Eₑ₂(Eₑ₁(X)) . . . ))=D_{d}(X_{e1, e2, . . . , ei}))=X. Here X_{e1, e2, . . . , ei} is a short notation of a predetermined sequence of encryption operations performed on (plaintext) content item X using encryption algorithm E and split-encryption keys e₁, e₂, . . . , eᵢ, respectively. Yet another group of split-key cryptosystems may be defined by crypto-algorithms E and D, a cipher algorithm for generating encryption and decryption keys e,d on the basis of secret information S and a split-key algorithm for multiple splitting of both e and d into an arbitrary number of i split-encryption keys e₁, e₂, . . . , eᵢ and k split-decryption keys d₁, d₂, . . . , dₖ (i,k≧1 and i+k≧2) such that D_{dk}(D_{dk-1}( . . . (D_{d2}(D_{d1} (Eₑᵢ(Eₑᵢ₋₁( . . . (Eₑ₂(Eₑ₁(X)) . . . ))=D_{dk}(D_{dk-1}( . . . (D_{d2}(D_{d1} (X_{e1, e2, . . . , ei}))=X.

In some embodiments E and D may be different algorithms. In other embodiments, the encryption and decryption algorithms E and D may be identical, i.e. E=D, which allows multiple splitting of both e and d into an arbitrary number i split-encryption keys e₁, e₂, . . . , eᵢ and k split-decryption keys dₖ, dₖ₋₁, . . . , d₁, such that D_{dk}(D_{dk-1}( . . . (D_{d2}(D_{d1}(Eₑᵢ(Eₑᵢ₋₁( . . . (Eₑ₂(Eₑᵢ(X)) . . . ))=E_{dk}(E_{dk-1}( . . . (E_{d2}(E_{d1}(Eₑᵢ(Eₑᵢ₋₁( . . . (Eₑ₂(Eₑᵢ(X)) . . . ))=X_{e1, e2, . . . , ei, d1, d2, . . . dk}=X.

In such split-key cryptosystem, there is no functional distinction between encryption keys e and decryption keys d. In some embodiments, the encryption and/or decryption algorithms may be communicative, i.e. they may be applied in any order always giving the same result. Such commutative property may be useful when split-keys are used in a different order as they are generated, or when they are used in an order that is unknown at the time of the generation of the split-keys. It is to be understood that whenever the term “such that” is used in the above referenced embodiments of (groups of) split-key cryptosystems, this term serves to define a property (behavior or characteristic) of such (group of) split-key cryptosystem(s).

Examples of the above-mentioned split-key cryptosystems will be described hereunder in more detail.

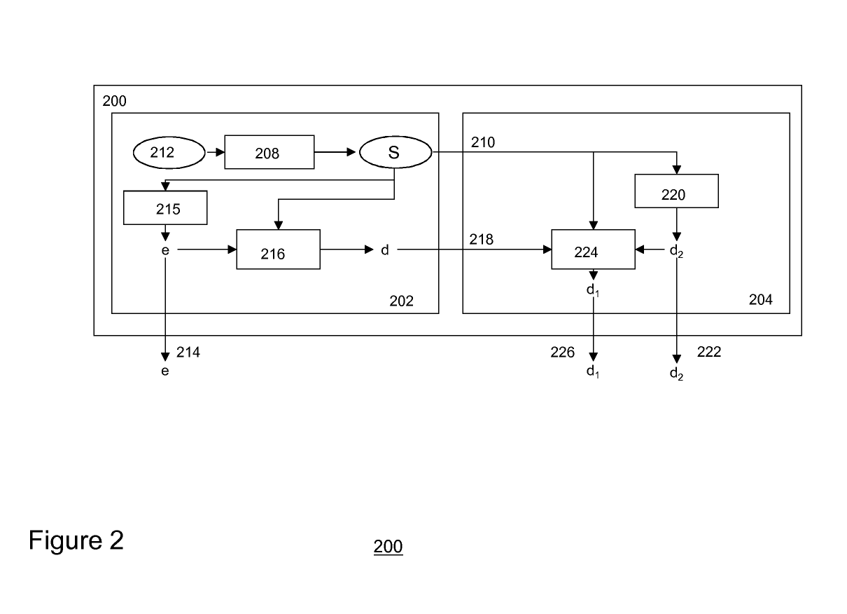

FIG. 2 depicts a schematic of a secret key generator 200 according to one embodiment of the invention. The secret key generator may comprise a cipher generator 202 for generating an encryption/decryption key pair e,d associated cipher algorithms. In one embodiment, such cipher algorithms may comprise a predetermined (pseudo) random cipher algorithm 215, a predetermined cipher algorithm 216 and a split-key generator 204 for generating split-keys on the basis of at least one of the encryption or decryption keys e,d and predetermined random split-key algorithm 220 and further split-key algorithm 220. In one embodiment, the further split-key algorithm may be a deterministic split-key algorithm. In other embodiments, the further split-key algorithm may comprise a pseudo random component. The cipher generator and split-key generator may be configured to generate the keys required for a predetermined split-key cryptosystem, which will be described hereunder in more detail.

In the example of FIG. 2 the cipher generator may comprise a pseudo random generator 208 configured to generate secret information S 210 on the basis of some configuration parameters 212, e.g. the length of encryption key(s), the length of decryption keys, the length of to-be-generated random numbers. Secret information S may be used for generating a (random) encryption key e 214 on the basis of a pseudo random key generator 215. A cipher algorithm 216 may use random encryption key e to generate decryption key d 218.

Secret information S may depend on the particular cipher algorithm used. In one embodiment, the secret information S may be information which is required to calculate d or e on the basis of the cipher algorithm and/or information which is required to calculate split-keys. For example, as described hereunder in more detail, when using the RSA scheme decryption key and split-decryption keys require knowledge of primes p and q in order to determine the Eurler's totient function φ(n).

In other embodiments, one could choose to keep certain information needed for generating d, e and split-key secret. For example, as described hereunder in more detail, in the RSA scheme, the EIGamal scheme and/or the Damgard-Jurik (DJ) scheme as described hereunder, one may decide to treat the parameters n and p not as public but as private (secret) information. For example, one may decide to transmit n or p as encrypted information to the CCU.

In yet other embodiments, the secret key information S may be “empty”, e.g. when the parameters n and p in the RSA scheme, the EIGamal scheme and/or the Damgard-Jurik (DJ) scheme are used as public information. In that case, no further secret information besides d is required to determine e (or vise versa).

Secret information S and decryption key d may be used by split-key generator 202 to generate split-keys, e.g. split-encryption keys and/or split-decryption keys. To that end, secret information S may be input to a pseudo random split-key generator 220 in order to generate a random split-decryption key d₂ 222. A further split-key cipher algorithm 224 may generate a further split-decryption key d₁ 226 on the basis of d and d₂.

In another embodiment, the split-key generator may be configured to generate on the basis of secret information S and d, k split decryption keys d₁, d₂, . . . , dₖ (k≧2). In a further embodiment, split-key generator may be configured to receive secret information S and encryption key e in order to generate i split encryption keys e₁, e₂, . . . , eᵢ (i≧2). In yet a further embodiment split-key generator may be configured to generate i split encryption keys e₁, e₂, . . . , eᵢ and k split decryption keys d₁, d₂, . . . , dₖ (i,k≧1 and i+k≧2) on the basis of secret information S and encryption/decryption key pair e,d.

As described above, encryption/decryption algorithm pairs E,D may be associated with a split-key algorithm for generating split-encryption and/or split-decryption keys. Hereunder a number of such split-key cryptosystems are described.

In a first embodiment, a split-key cryptosystem may be based on the symmetrical encryption algorithm known as the “one-time pad”. In this embodiment, an encryption key e may be generated in the form of a long random binary number generated using a random generator. Encryption algorithm E may be a binary function for encrypting content item X into an encrypted content item Xₑ by applying an exclusive-or (XOR, D) operation to X using e:

e=RAN_{—}1

Xₑ=E_{pT}(X)=X⊕e

A first split-decryption key d₁ and second split-decryption key d₂ may be formed on the basis of e. For example, second split-decryption key d₂ may be a random binary number having the same length as e and first split-decryption key d₁ may be generated by executing a bitwise exclusive-or operation between d₁ and e:

d₂=RAN_{—}2

d₁=d₂⊕e

A first decryption operation may “partially” decrypt encrypted content item Xₑ into X_{e,d1} by executing a bitwise exclusive-or operation on Xₑ and d₁. A second decryption operation may fully decrypt partially decrypted content item X_{e,d1} into content item X by executing an exclusive-or operation on the basis of X_{e,d1} and d₂:

X_{e,d1}=D_{d1}(Xₑ)=Eₑ(X)⊕d₁

X_{e,d1,d2}=D_{d2}(X_{e,d1})=D_{d1}(Xₑ)⊕d₂=X

If the binary values e, d₁ and d₂ are shorter than content item X, each of them may be concatenated with itself several times, and then truncated to the length of content item X. However, such concatenation would reduce the security of the system.

The above described double split-key “one-time pad” cryptosystem may be easily generalized to a split-key cryptosystem with k split-decryption keys and/or i split-encryption keys. For example, in one embodiment, instead of choosing long binary streams d₁ and d₂ such that d₁⊕d₂=e, k−1 random binary streams d₁ . . . dₖ₋₁ may be generated and the final random binary stream may be determined using the deterministic relation dₖ=d₁⊕ . . . ⊕dₖ₋₁⊕e.

In a similar way a split-key cryptosystem with i split-encryption keys and k split-decryption keys may be generated. In this embodiment encryption and decryption algorithms D,E are identical, i.e. both are performed as an exclusive-or operation. Further, the encryption and decryption algorithms are commutative, so the split-keys may be generated in any desired order and the encryption and decryption operations may be performed in any desired order.

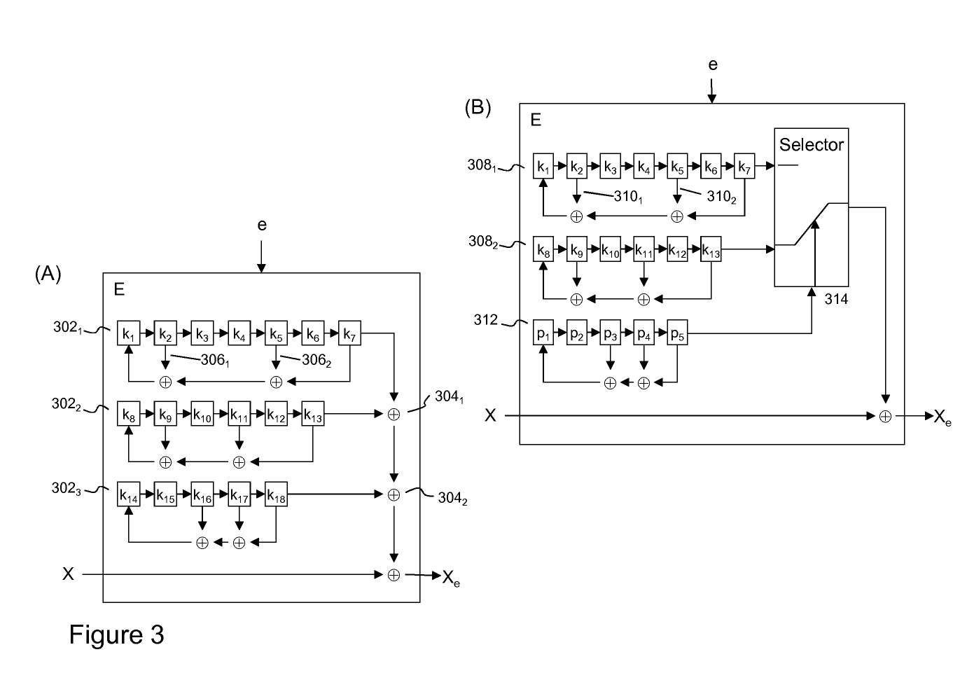

In second embodiment, a split-key cryptosystem may be based on a symmetric stream cipher. FIGS. 3(A) and (B) depict stream ciphers for use in a split-key cryptosystem according to various embodiments of the invention.

In particular, FIG. 3(A) depicts a linear stream cipher as an encryption algorithm E providing bitwise encryption of content item X into Xₑ on the basis of encryption key e. The linear stream cipher may use one or more multiple linear feedback shift registers (LFSR) 302₁-302₃, which may be combined by one or more XOR functions 304₁,304₂. An LFSR may comprise one or more preconfigured taps 306₁,306₂. A key k may form the start state of the (in this example three) LFSRs {k₁, k₂, k₃, . . . , kₘ} and the linear stream cipher is linear for used keys k.

In this split-key cryptosystem encryption key e and first split-decryption key may be generated as a set of random bits {e₁, e₂, e₃, . . . , eₘ} and {d₁₁, d₁₂, d₁₃, . . . , d₁ₘ} respectively and split-decryption key d₂ may be calculated as a bitwise XOR of e and d₁, i.e. d₂=e⊕d₁.

FIG. 3(B) depicts a non-linear stream cipher using one or more multiple linear feedback shift registers (LFSR) 308₁,308₂ (optionally comprising one or more preconfigured taps 310₁,310₂) which may be combined using a partial non-linear “combination generator”. Two or more LFSRs 308₁,308₂ may be configured to generate pseudo-random bit streams, where a key k may form the start state of the LFSRs {k₁, k₂, k₃, . . . , kₘ}. One or more further LFSRs 312 may be configured as a non-linear “combination generator” 314 (selector).

In this particular embodiment, the output of a further LFSR is used to select which bit of the other two LFSRs is taken as the output 316 of the selector. The bits p {p₁, p₂, p₃, . . . , pₙ}defining the start state of the further LFSR may be pre-configured. As the stream cipher is linear in k, the decryption key may be calculated as a bitwise XOR of e and d₁, i.e. d₂=e⊕d₁. Also other partial non-linear functions may be used as a combination generator.

Stream ciphers form easy implementable symmetrical ciphers requiring keys of much shorter lengths when compared to the one-time path algorithm. The non-linear part of a partial non-linear combination generator makes the cipher more secure against certain types of attacks.

In a third embodiment, a split-key cryptosystem may be based on the asymmetrical encryption algorithm known as the RSA encryption scheme. In that case, an encryption/decryption key pair e,d using the following cipher algorithms:
Randomly select two distinct prime numbers p and q of similar bit-length;
Compute n=p*q;
Compute φ(n)=(p−1)*(q−1) wherein φ is Euler's so-called totient function;
Randomly select an integer e such that 1<e<φ(n) and gcd(e,φ(n))=1 (i.e., e and φ(n) are coprime);

Determine d by calculating the multiplicative inverse of e (mod φ(n)), i.e.: d=e⁻¹(mod φ(n)).

The parameters p,q,φ(n),e,d and n may be stored as secret information for further use. In particular, the value n needs to be shared with the content distributor (if decryption on the basis of split-key information is performed in a CDN) and the CCU, as these entities require n to perform their encryption and decryption operations. The value n may be transferred to the content distributor and the CCU in protocol messages associated with a content transaction. In one embodiment, when multiple transactions use the same secret information, n needs to be communicated only once.

A content item X may be processed on the basis of an agreed-upon reversible protocol known as a padding scheme, which turns X into an integer x wherein 0<x<n. If the process determines that X is too long, it may divide X in blocks that each satisfies the length requirement. Each block is thereafter separately processed in accordance with the padding scheme.

The RSA encryption algorithm E for encrypting X into Xₑ may be calculated as follows:

Xₑ=Eₑ(X)=x^{e}(mod n).

A split-key algorithm for determining a pair of split-decryption keys d₁,d₂ may comprise the steps of:
selecting an integer d₁ randomly such that 1<d₁<φ(n) and wherein d₁ and φ(n) are coprime;
determining d₂=d₁⁻¹*d(mod φ(n)).

A first decryption operation based on decryption algorithm D and split-encryption key d₁ may generate a “partially” decrypted content item by calculating X_{e,d1}=D_{d1}(Xₑ)=(Xₑ^{d1})(mod n) (Read: Xₑ to the power d₁ followed by a modulo n operation). A second decryption operation based on decryption algorithm D and split-encryption key d₂ may generate X_{e, d1, d2}=D_{d2}(X_{e,d1})=(X_{e,d1}^{d2})(mod n). The original plaintext content item X may be derived from X_{e, d1, d2} by applying the padding scheme in reverse.

Since the RSA encryption and decryption algorithms E and D are identical, the split-key algorithm for determining a pair of split-encryption keys e₁, e₂ may be determined on the basis of the same algorithm for determining the split-decryption keys.

The above double split-key RSA cryptosystem may be generalized to a multiple split-key cryptosystem with k keys. To that end, instead of selecting d₁ and d₂ such that d₁*d₂=d(mod φ(n)), k−1 random (preferably different) integers d₁, . . . , dₖ₋₁ which are coprime with φ(n) are determined and the final integer split-key dₖ is computed according to the deterministic relation: dₖ=(d₁* . . . *dₖ₋₁)⁻¹*d(mod φ(n)). RSA encryption and decryption algorithms E,D are commutative, so the keys may be generated in any desired order and the encryption and decryption operations may be performed in any desired order.

The split-key RSA cryptosystem has the additional advantage that RSA keys cannot be split without secret information φ(n). This way, it is assured that no unauthorized party can split keys provided by the SKG. This will prevent so-called man-in-the-middle attacks wherein a man-in-the-middle intercepts a key provided by the SKG and combines it with his own secret key. Furthermore, this also allows provisioning of second split-key information to the CCU without the use of a secure channel (as described with reference to FIG. 1).

Thus, in one embodiment, when using a split-key RSA cryptosystem according to the invention second split-key information may be provisioned to the CCU via a non-secured channel e.g. broadcast or multicast. Alternatively, second split-key information may be stored together with encrypted content on an optical or magnetically storage medium wherein the split-key is stored in an unprotected storage area of the DVD.

In fourth embodiment, a split-key cryptosystem may be formed on the basis of the asymmetrical encryption algorithm known as the EIGamal (EG) encryption scheme. The EG scheme is based on the discrete logarithm problem rather than the factoring problem of RSA. In that case, encryption/decryption key pair e,d may be determined on the basis of the cipher algorithms:
Select a large prime number p and a generator g that generates the multiplicative group {0, 1, . . . , p−1} mod p;
Determine d by selecting a random number: dε{1, . . . , p−2};
Compute h=(g^{d})(mod p);
Determine public key e=(p, g, h).

Note that e is called “public” because it could be published without leaking secret information. In one embodiment, e may be published to enable third parties (e.g. users that generate and upload user-generated content) to encrypt content for the system, while the content source or content provider (CS, CPS) remains in fully control over the (partial) decryption steps. However, when there is no need to publish e, it is kept private.

Decryption key d and (public) encryption key e=(p, g, h)—wherein p, g, h are integers—may be stored as secret information for future use. In particular, the value p needs to be shared with the content distributor (if decryption on the basis of split-key information is performed in a CDN) and the CCU, as these entities require p to perform their encryption and decryption operations. The value of p may be included in protocol messages exchanged during a content transaction between a content provider and a CCU. In one embodiment, multiple transactions may use the same secret information. In that case, p would need to be communicated to the content distributor and a CCU only once.

A content item X may be processed on the basis of an agreed-upon reversible protocol known as a padding scheme, which turns X into an integer x wherein 0<x<p. If the process determines that X is too long, it may divide X in blocks that each satisfies the length requirement. Each block is thereafter separately processed in accordance with the padding scheme.

Encryption algorithm Eₑ(X) for encrypting content item X into Xₑ may comprise the steps of:
select a random number sε{1, . . . , p−2};
determining Xₑ=Eₑ(X,s)=(Y₁,Y₂)=((g^{s})(mod p),(X*h^{s})(mod p))

Similarly, a decryption operation D_{d}(Y₁,Y₂) for decrypting an encrypted content item Xₑ may be computed as:
D_{d}(Y₁,Y₂)=(Y₁^{-d}*Y₂)(mod p) (which indeed equals (g^{-ds}*h^{s}*X)(mod p)=X)

A split-key EG algorithm for determining a pair of split-decryption key d₁,d₂ may comprise the steps of:
determining d₁ to be a random number d₁ε{1, . . . , p−2};
compute d₂=(d−d₁) mod p.
   The above-described double split-key EG cryptosystem may be generalized to a multiple split-key cryptosystem using k split-encryption keys. To that end, instead of choosing d₁ and d₂ such that d₁+d₂=d mod p, k−1 random integers d₁ . . . dₖ₋₁ smaller than p may be selected and the final integer may be computed according to the relation dₖ=d−(d₁+ . . . +dₖ₋₁)(mod p).

A split-key EG algorithm for splitting the random encryption parameter s into I parts may be defined as follows:
The first party selects a random number sε{1, . . . , p−2};
The first party chooses I random numbers sᵢε{1, . . . , p−2}, 1≦i≦I, such that s=(s₁+s₂+ . . . +s_{I}) mod p and sends sᵢ to party i;
Let Y₁=(h^{s}^{₁}*X) mod p.
For i=1 to I−1 do
   Party i sends (g^{s} mod p, Yᵢ) to party i+1;
   Party i+1 performs its encryption step:
   Yᵢ₊₁:=(h^{s}^{ᵢ}*Yᵢ) mod p.

It may be easily verified that (g^{s} mod p, Y_{I})=Eₑ(X, s), because s=(s₁+s₂+ . . . +s_{I}) mod p. The different encryption steps are commutative.

A first decryption operation on the basis of decryption algorithm D and d₁ may be used to “partially” decrypt encrypted content Xₑ into X_{e,d1} by calculating D_{d1}(Xₑ)=D_{d1}(Y₁,Y₂)=(Y₁, Y₁^{-d1}*Y₂(mod p)). Partially decrypted content X_{e,d1} is represented by a pair with the same first element Y₁. Since Y₁ is part of the encryption, it may be included in the protocol messages.

A second decryption operation on the basis of decryption algorithm D and d₂ may be used to determine the fully decrypted content by calculating X_{e, d1, d2}=D_{d2}(Xₑ,d₁) wherein the second element of X_{e, d1, d2} will equal x: X_{e, d1, d2}=D_{d2}(X_{e,d1})=D_{d2}(D_{d1}(Y₁,Y₂))=(Y₁, Y₁^{-d2}*Y₁^{-d1}*Y₂)(mod p))=(Y₁, (Y₁-d*Y₂)(mod p))=(Y₁, X). Original content item X may be determined from the calculated X_{e, d1, d2} by applying the padding scheme in reverse.

The EG decryption algorithm D is commutative, so the decryption keys can be generated in any desired order and the decryption operations may be performed in any desired order. Similarly, the encryption algorithm is also communicative, so encryption keys may be generated in any desired order and the encryption operations may be performed in any particular order.

It is noted that the above-described RSA and EG split-key cryptosystems are multiplicative homomorphic, exhibiting the property D(E(Z₁)*E(Z₂))=(Z₁*Z₂)(mod p). In the context of signal processing an additive homomorphic scheme may have advantageous properties e.g. it allows the addition of a watermark to an encrypted signal. An additive homomorphic cryptosystem exhibits the property D(E(Z₁)*E(Z₂))=(Z₁+Z₂)(mod p).

In a fifth embodiment, a split-key cryptosystem may be based on an additive homomorphic cryptosystem known as the Damgård-Jurik (DJ) cryptosystem.

The encryption/decryption pair e,d for the DJ cryptosystem may be generated using the following cipher algorithms:
Select two large prime numbers p′ and q′ such that p=2p′+1 and q=2q′+1 are prime too and wherein n=p*q is defined as the modulus of the system;
Select a generator g that generates all squares of the multiplicative group {1, . . . , n−1} mod n. The group of all squares will have size τ=p′*q′;
Select d as a random value dε{1, . . . , τ−1} and compute h=g^{d} mod n;
Determine the (public) encryption key e=(n, g, h).

Note that e is called “public” because it could be published without leaking secret information. In one embodiment, e would be published to enable third parties (e.g. users that generate and upload user-generated content) to encrypt content for the system, while the content provider (CS, CPS) remains in fully control over the (partial) decryption steps. However, when there is no need to publish e, it is kept private (i.e. secret).

The values p, q and d may be stored as secret information S together with e=(n, g, h). The value of n needs to be shared with the content distributor and the CCU, as these entities require n to perform their encryption and decryption operations. The value of n may be included in protocol messages exchanged during a content transaction between a content provider and a CCU. In one embodiment, multiple transactions may use the same secret information. In that case n would need to be communicated to the content distributor and the CCU only once.

A content item X may be processed on the basis of an agreed-upon reversible protocol known as a padding scheme, which turns X into an integer x wherein 0<x<n. If the process determines that X is too long, it may divide X in blocks that each satisfies the length requirement. Each block is thereafter separately processed in accordance with the padding scheme.

An encryption algorithm Eₑ(X) for encrypting content X into Xₑ may comprise the steps of:
selecting a random number rε{0, . . . , n−1};
computing g′=g^{r} mod n and h′=h^{r} mod n such that Xₑ=Eₑ(X, r)=(Y₁,Y₂)=(g′, h′ⁿ*(n+1)^{X} mod n²).

The decryption algorithm D_{d}(Y₁,Y₂) for decrypting an encrypted content item Xₑ may comprise the steps of:
calculate H′=(Y₂*g′^{(-d*n)})(mod n²)
determine X=X_{e,d}=(H′−1)*n⁻¹ mod n²

This indeed gives the desired result X_{e,d}=D_{d}(Y₁,Y₂)=X because in equation a) H′=((n+1)^{X})(mod n²)=(n*X+1)(mod n²). A split-key algorithm for determining a pair of split-decryption keys d₁ and d₂ may comprise the steps of:
determine d₂ to be a random number d₂ε{0, . . . , n−1};
compute d₁=(d−d₂) mod n.

A split-key EG algorithm for splitting the random encryption parameter r into I parts may be defined as follows:
The first party selects a random number rε{1, . . . , p−1};
The first party chooses I random numbers rᵢε{1, . . . , p−1}, 1≦i≦I, such that r=(r₁+r₂+ . . . +rᵢ) mod n and sends rᵢ to party i;
Let Y₁=(h^{n*r}^{₁}*(n+1)^{X}) mod n².
For i=1 to I−1 do
   Party i sends (g^{r} mod n, Yᵢ) to party i+1;
   Party i+1 performs its encryption step:
   Yᵢ₊₁:=(h^{n*r}^{₁}*Yᵢ) mod n².

It may be easily verified that (g^{r} mod n, Y_{I})=Eₑ(X, r), because r=(r₁+r₂+ . . . +r_{I}) mod n. The different encryption steps are commutative.

A first decryption operation on the basis of decryption algorithm D and d₁ may be used to “partially” decrypt” encrypted content Xₑ into X_{e,d1} by calculating D_{d1}(Xₑ)=D_{d1}(Y₁,Y₂)=(Y₁,Y′₂)=(Y₁,(Y₁^{(-d}^{₁}^{*n)}*Y₂)(mod n²)). Hence, “partial” decrypted content X_{e,d1} is represented by the pair (Y₁,Y′₂) wherein Y₁ may be typically included in the protocol messages. In one embodiment, if multiple transactions are based on the same secret information and the same random number r, then Y₁ does not chance and may need to be communicated to the content distributor and the CCU only once.

A second decryption operation on the basis of algorithm D and d₂ may be used to determine the fully decrypted content by calculating H′=(Y₁^{(-d2*n)}*Y′₂)(mod n²) and x=((H′−1)*n⁻¹) mod n². Indeed, H′=(Y₁^{-(d2+d1)n}*Y₂) mod n²=(Y₂*g′^{(-d*n)})(mod n²) thus showing the correctness of the split-key cipher.

The above split-key DJ cryptosystem may be easily generalized to a multiple split-key cryptosystem with k split-decryption keys. To that end, instead of choosing d₁ and d₂ such that d₁+d₂=d mod n, k−1 random integers d₁ . . . dₖ₋₁ smaller than n may be selected and the final integer may be computed as dₖ=d−(d₁+ . . . +dₖ₋₁)(mod n).

The DJ decryption algorithm D is commutative, so the decryption keys may be generated in any desired order and the decryption operations may be performed in any desired order. The same holds for the encryption algorithm.

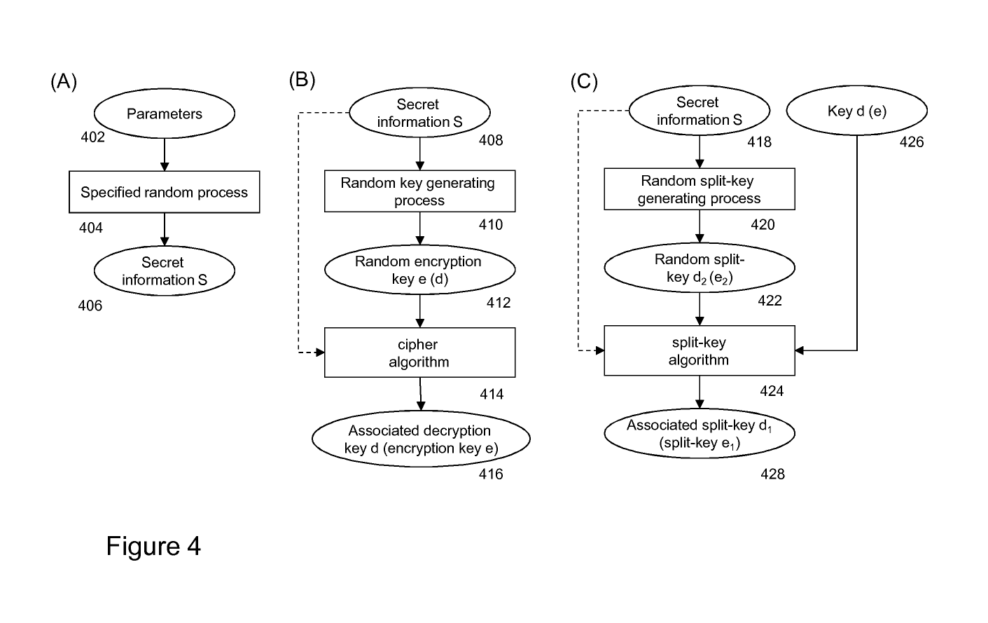

FIG. 4 depicts flow charts illustrating the generation of the encryption/decryption pair e,d and associated split-keys according to various embodiments of the invention. In particular, the flow charts correspond to the processes executed in the secret key generator as described with reference to FIG. 2. FIG. 4(A) depicts the generation of secret information S. In a first step 402 parameters are determined, like the lengths of keys or lengths of prime number that are to be generated. These parameters are used as input for a random process function 404. The random process function may be a pseudo-random generator or a physical random generator based on a physical process, e.g. thermal noise, for producing secret information S. Based upon the seed and the specific cryptosystem the random generator may generate secret information S 406.

FIG. 4(B) depicts the generation of encryption key e and decryption key d. The secret information S 408 may be used in a specific random process 410 associated with a specific cryptosystem for generating random encryption key e 412. For example, when using the RSA cryptosystem (as described above), encryption key e may be determined on the basis of a process including the random selection of two distinct prime numbers p and q and the subsequent random selection of an integer e such that 1<e<φ(n) and gcd(e,φ(n))=1 wherein n=p*q.

Similarly, when using the EG cryptosystem (as described above), encryption key e may be determined on the basis of process including selection a large prime number p and a generator g that generates the multiplicative group {0, 1, . . . , p−1} mod p and subsequent determination of d by random selection from this group dε{1, . . . , p−2}.

Then, on the basis of the random encryption key e and a predetermined deterministic cipher algorithm 414 associated with the cryptosystem, associated decryption key d 416 may be determined. For example, when using the RSA cryptosystem, decryption key is calculated as d=e⁻¹(mod φ(n)). In some embodiments secret information S may also be used in the calculation of d. For example, in the above referred to RSA case, decryption key is calculated by using φ(n), which is part of the secret information S.

In other embodiments, decryption key d may be determined on the basis of a certain random process and encryption key e may be calculated using a predetermined cipher algorithm (such as the EG or DJ cryptosystem).

FIG. 4(C) depicts the generation of split-keys d₁ on the basis of secret information S. Secret information S 418 may used by a specific random split-key generating process 420 associated with a specific cryptosystem thereby generating first split-key d₂ 422. For example, when using the RSA cryptosystem (as described above), split-key d₂ may be determined on the basis the random selection of an integer d₁ such that 1<d₁<φ(n) and gcd(d₁,φ(n))=1 (i.e. similar to the determination of e).

Thereafter, on the basis of d₂ 422 and d 426 (and—in some embodiments, on the basis of secret information S) associated split-key d±428 may be determined using a deterministic split-key algorithm 424. For example, in the RSA case the associated split-key may be calculated as d₁=(d₂⁻¹*d)(mod φ(n)).

Hence, from the above it follows that various symmetric and asymmetric cryptosystem may be associated with a split-key algorithm allowing multiple splitting of decryption and/or encryption keys d and e respectively. These split-key cryptosystems may be implemented in a content delivery system comprising as described with reference to FIG. 1. Table 1 provides a comprehensive overview of key information and part of the information, which needs to be distributed to the CS, the CD and the CCU for the different cryptosystems. From this table, it follows that for the split-key RSA, EG and DJ cryptosystems not only the split-keys d₁ and d₂ but also n (RSA and DJ) and p (EG), are sent to the CD and the CCU respectively.

This information may be sent in a suitable “encryption container” to the entities in the content distribution system. In particular, it may use a so-called split-encryption control message (SECM) to send encryption information to a specific entity configured for (partially) encrypting a content item (e.g. an encryption module associated with the CS) and a split-decryption control message (SDCM) to send decryption information to as specific entity configured for (partially) decrypting a content item (e.g. a CDN of CCU decryption module).

TABLE 1
overview of the information generated by the secrete key
generator (SKG) and send to the encryption module in the
content source (CS) and the decryption nodule in the CCU.

| Crypto- | | | |
|---|---|---|---|
| system | SKG → CS | SKG → CCU | SKG → CCU |
| One-time | e = long sequence of | d₁ = long | d₂ = long |
| pad | random bits | sequence of | sequence of |
| | | random bits | random bits |
| LFSR- | e = LFSR description | d₁ = LFRS | d₂ = LFRS |
| based | (initial state, taps, | description | description |
| | combining functions | | |
| | like ASG (Alternating | | |
| | Step Generator), . . .) | | |
| RSA | p, q | n, d₁ | n, d₂ |
| | {n = p * q} | | |
| | e, d | | |
| EIGamal | p, g, d | p, d₁ | p, d₂ |
| | {h = g^{d} mod p}, s = | | |
| | random integer of | | |
| | size p | | |
| Damgård- | p, q, g, d | n, d₁ | n, d₂ |
| Jurik | {n = p * q; | | |
| | h = g^{d} mod n}, r = | | |
| | random integer of | | |
| | size n | | |

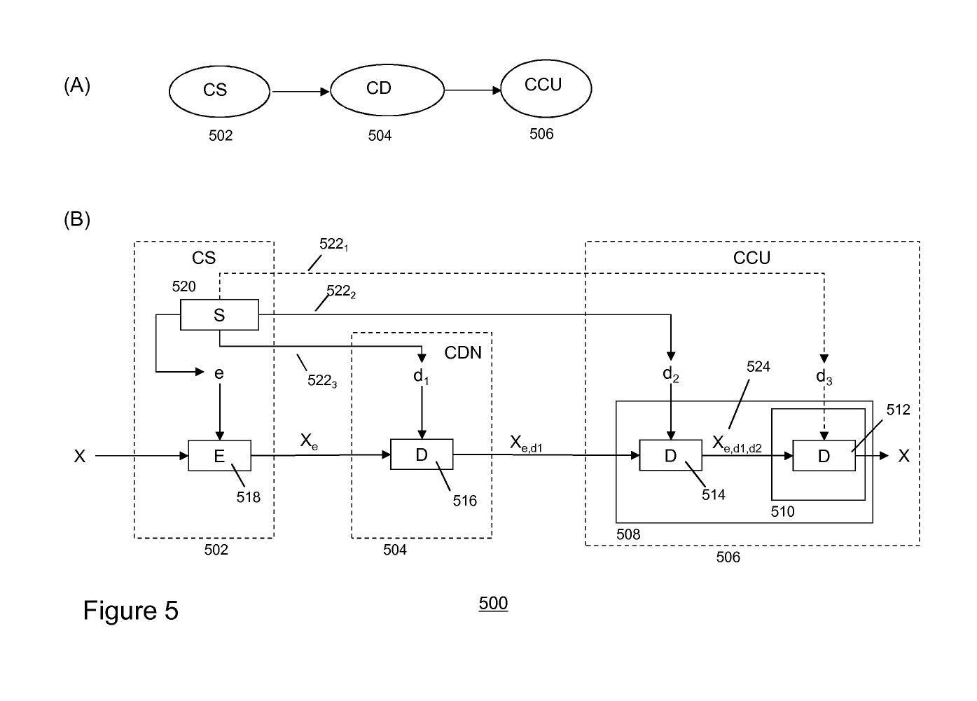

FIG. 5(A) depicts a high-level schematic of a content distribution system. The system may generally comprise a content source (CS) 502 and a content distributor (CD) 504 for distributing content to one or more content consumption units (CCU) 506. Here, CD relates to a third-party content distributor, i.e. one or more content distribution systems which are not part of the CPS. Hence, in the content distribution system of FIG. 5(A) content provider outsources the content delivery of the content to a consumer to an intermediate party, a content distributor.

When outsourcing the delivery of the content, a certain trusted relation between the content provider and the content distributor, such as a content delivery network (CDN), is needed such that the content provider can rely on the content distributor that the content is delivered in accordance to certain predetermined conditions, e.g. secure delivery, and that the content provider is correctly paid for each time that a consumer requests a particular content item from the content distributor. Hence, as the CS has delegated the delivery of the content to one or several content distributors, the risk of unauthorized access is increased. The content therefore requires protection by a content protection system.

As will be described hereunder in more detail, the split-key cryptosystem as described in this disclosure allows a content originator to be in full control of the secure delivery of the content even though the actual delivery of the content is outsourced to one or more content distributors. Here, a content distributor may relate to a content distribution platform or a chain of different content distribution platforms configured to distribute content from the content source to the content consumption units. A content distribution platform may use electronic means for delivering content e.g. one or more content delivery networks (CDNs) or it may use physical means for delivering content, e.g. s recording-medium such as a magnetic recoding medium, an optical recoding medium using e.g. DVD and Blu-Ray technology or an opto-magnetic recording medium.

FIG. 5(B) depicts the use of a split-key cryptosystem in a content delivery system of FIG. 5(A) according to one embodiment of the invention. In particular, FIG. 5(B) depicts a CPS 502 comprising key generator S 520 and an encryption module E 518 and a CCU 506 comprising a secure (decryption) module 508 configured for decrypting encrypted content items on the basis of decryption algorithm D similar to the content distribution system as described with reference to FIG. 1(B). The system in FIG. 5(B) further comprises a CDN comprising a decryption module 516 comprising decryption algorithm D. The decryption module is configured to receive split-key information, including a split-key d₁. Hence, in this embodiment secret key generator SKG 520 may generate split-key information including a split-key d₃ 522₁ and (pre)provision the decryption module in the CCU with this split-key information in a similar manner as described with reference to FIG. 1(B). Also in this case, (pre)configuration may include storing or embedding split-key information, including split-key d₂, in a secure hardware unit 510, which may be part of the decryption module.

Further, encryption module may be configured to receive encryption information, which may include encryption key e, to generate an encrypted content item, which is subsequently ingested and stored in CDN 504. When a user of the CCU requests content item X, the CCU may send a content request to CPS, which may subsequently invoke the key generator to generate split-key information, e.g. split-keys d₁ 522₂ and d₂ 522₃. Split-key d₁ is sent to the CDN, which may use d₁ to generate partially decrypted content item X_{e,d1}, which is sent to the decryption module in the CCU. Partially decrypted content item X_{e,d1}, may be further decrypted into further partially decrypted content item X_{e,d1}, d₂, which thereafter is fully decrypted on the basis of d₃. Hence, this embodiment combines the advantages of the secure content delivery system depicted in FIG. 1 with the added security of having each content item uniquely encrypted for each CCU.

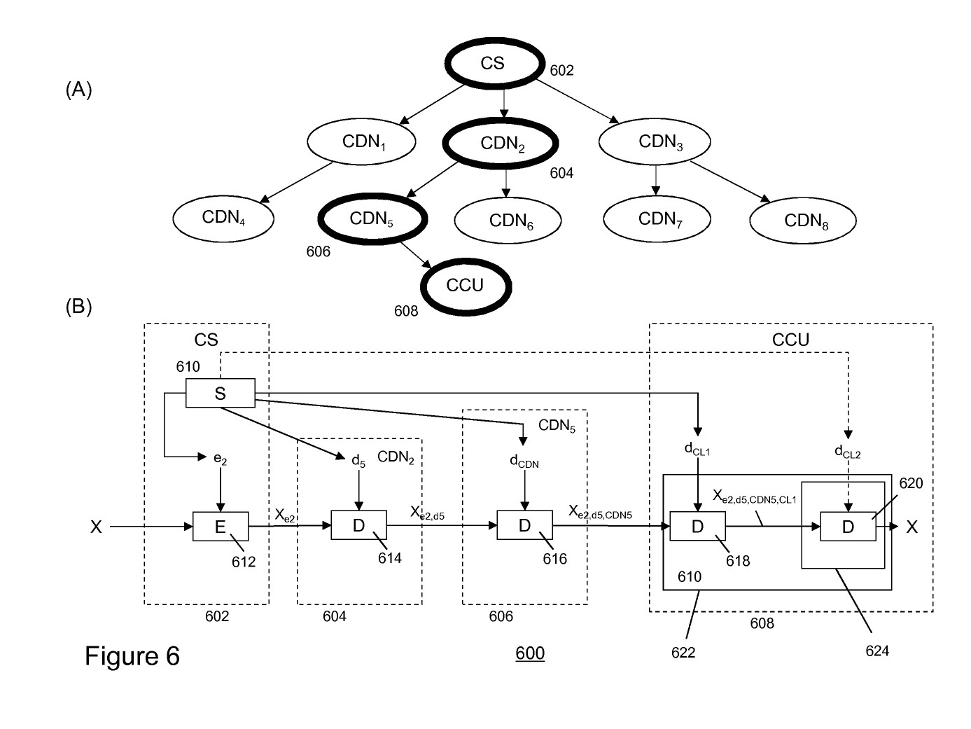

FIG. 6 depicts the use of a split-key cryptosystem in a content delivery system comprising a network CDNs according to an embodiment of the invention. In particular, FIG. 6(A) depicts a CS 602 connected to a CDN network CDN₁₋₈ wherein certain CDNs, e.g. “upstream” CDN₂ may outsource the delivery of a content item X to “downstream” CDN₅. As will be shown below, the split-key cryptosystems according to the present invention are particularly suited for providing secure content distribution from the CS via the CDN network to the CUU.

In this non-limiting example, the split-key cryptosystem may use e.g. three split-encryption keys e₁, e₂, e₃ for encrypting content. This way, CS may send e.g. three encrypted versions of content item X to CDN₁, CDN₂ and CDN₃, respectively, wherein each of these versions has been encrypted with its own encryption key so that CDN₁ receives Xₑ₁, CDN₂ receives Xₑ₂ and CDN₃ received Xₑ₃. Then, based on the associated decryption key d, secret key generator may generate multiple split-decryption keys, in this example five (random) split-decryption keys d₄, . . . , d₈, which may be used when delivery of content item X is outsourced to CDN₄-CDN₈. Moreover, a further (random) split key may be used to (pre)configure a decryption module 620 in the secure hardware module of the CCU with a split-key d_{CL2} as described with reference to FIG. 1.

In particular, upon ingestion of content item Xₑ₁ by CDN₄, CDN₁ may “partially” decrypt content item Xₑ₁ into X_{e1,d4} before it is sent to CDN₄ which subsequently stores X_{e1,d4} for future delivery to a CCU. In a similar way, CDN₅ may receive “partially” decrypted item X_{e2,d5}, (received from CDN2), CDN6 may receive and store “partially” decrypted item X_{e2,d6} (received from CDN₂), CDN₇ may receive and store “partially” decrypted item X_{e2,d7}, (received from CDN3), and CDN8 may receive and store “partially” decrypted item X_{e3,d8}, (received from CDN3).

When a content item is requested by a CCU, the selected CDN (e.g. one of CDN₄-CDN₈) would apply a further partial decryption step to the partially decrypted content on the basis of a split-key sent by the CS. This process is depicted in FIG. 6(B), illustrating the secret key generator 610 associated with the CPS 602 generating split-keys for the split-key cryptosystem in order to guarantee secure delivery of content item X from CPS via CDN₂ 604 and CDN₅ 606 to the requesting CCU 608. In this case, the CCU may comprise a secure module 622 with a first (split-key) decryption module 618 and a second (split-key) decryption module 620 wherein second decryption module may be (pre)configured with a split-key, in this case d_{CL2}.

In one embodiment, second decryption module 610 may be implemented as a secure hardware module 624 comprising split-key d_{CL2}. As described above, delivery of content item X was outsourced by CDN₂ to CDN₅ so that the encrypted content Xₑ₂ was first “partially” decrypted on the basis of split-decryption key d₅ into X_{e2,d5} before it was sent to CDN₅.

Then, if a consumer decides to purchase content item X, the content delivery system may redirect the content of the consumer to CDN₅, which—upon reception of the request—may signal the secret key generator to generate two further split-decryption key d_{CDN5} and d_{CL1} using a split-key algorithm e.g. the EG split-key algorithm: d_{CDN5}+d_{CL1}=(d₂−d₅−d_{CL2})(mod p). Here d₂ is the split-decryption key associated with split-encryption key e₂ that was used by encryption module 612 to generate Xₑ₂, for example for RSA d₂=e₂⁻¹(mod (φ(n)), which was distributed to CDN₂. Further, d₅ is the decryption key that decryption module 614 of CDN₂ used to generate X_{e2,d5}, which CDN₂ distributed to CDN₅ and d_{CL2} is the split-key which was provisioned to the CCU. The CS may send split-key d_{CDN5} to decryption module 616 of CDN₅. Further, split-key d_{CL1} may be sent to the decryption module 622 in to the secure hardware module of the CCU. Here, decryption module may be configured to execute at least a first split-decryption operation 618 using decryption algorithm D and first split-key information comprising at least a first split-key d_{CL1} and a second split-key operation 620 using decryption algorithm D and second split-key information comprising at least a second split-key d_{CL2}. The decryption module is implemented as a secure module, e.g. a smart card, (U)SIM or other suitable hardware-secured processor. CDN₅ may partially decrypt X_{e2,d5} with d_{CDN5} into X_{e2, d5, dCDN5} and send it to the CCU, which may invoke decryption operations 618,620 to perform the final decryption steps by calculating X_{e2, d5, dCDN5, CL1} and X_{e2, d5, dCDN5, CL1, CL2}. The thus fully decrypted content X=X_{e2, d5, dCDN5, dCL1, dCL2} may be displayed to the consumer through a display module associated with the CCU.

This embodiment illustrates that the split-key cryptosystem is particularly suitable for secure content delivery via a CDN network to a large number of CCUs. Whenever a CDN outsources a content item or a CUU requests a content item, the CS is contacted to generate a split-key. This way, the delivery of the content item through the CDN network is completely transparent. Furthermore, at any moment no CDN has all keys necessary to fully decrypt the content, so that secure transport and delivery of a content item is therefore possible. Hence, this embodiment combines the advantages of the secure content delivery system depicted in FIG. 1 with the added security of having each content item uniquely encrypted for each CDN in a network of CDNs.

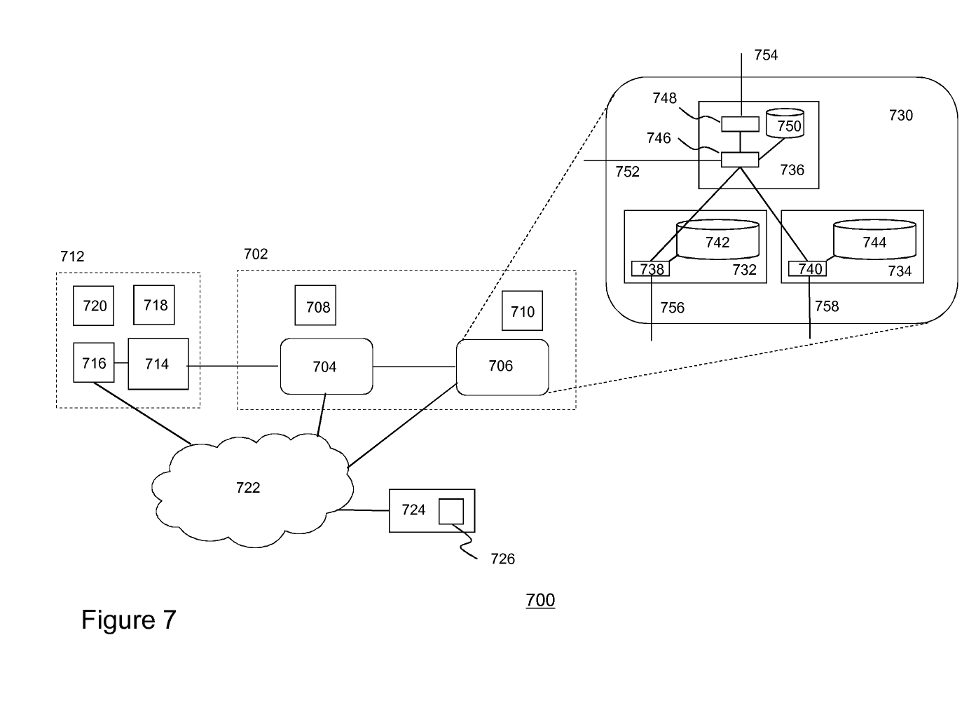

FIG. 7 depicts a schematic of a secure content delivery system for delivering content to a content consumption unit according to an embodiment of the invention. In this particular embodiment, the content distributor 702 is implemented as a content delivery network (CDN) or a network of CDNs, e.g. a first CDN 704 associated with a first decryption module 708 and a second CDN 706 associated with a second decryption module 710.

Content source 712 may comprise a content provider system (CPS) 714 connected to a web portal 716. The CPS may be associated with an encryption module 718 and a secret key generator 1120. One or more CCUs 724 comprising a decryption module 1126 may be communicated via transport network 1122 to the content source and the content distributor.

The CPS may be configured to offer content items, e.g. video, pictures, software, data and/or text in the form of files and/or streams to customers. A customer may buy these content items by accessing web portal 716 on his CCU. A CCU may communication with the CDN and the CPS using a client.

The CDN is configured to efficiently deliver content items to the CCU. Delivery of a content item may be in the form of a live stream, a delayed stream or a content file. Here, a content file may generally relate to a data structure used for processing content data belonging to each other. A file may be part of a file structure, wherein files, including content files, are stored and ordered in a directory and wherein each file is identified by a file name and a file name extension.

Inset 730 depicts CDN in more detail. A CDN may comprise delivery nodes 732,734 and at least one central CDN node 736. Delivery nodes may be geographically distributed throughout the CDN. Each delivery node may comprise (or be associated with) a controller 738,740 and a cache 742,744 for storing and buffering content. The controller may be configured to set up communication session 756,758 with one or more CCUs.

A central CDN node may comprise (or may be associated with) an ingestion node (or content origin function, COF) 748 for controlling ingestion of content from an external source 754 (e.g. a content provider or another CDN). Further, the central CDN may be associated with a content location database 750 for storing information about the location where a content item is stored within a CDN and a CDN control function (CDNCF) 746 for controlling the distribution of one or more copies of a content item to the delivery nodes and for redirecting clients to appropriate delivery nodes (the latter process is also known as request routing). The CDNCF may further be configured to receive and transmit signaling messages from and to a CPS, another CDN and/or a content consumption unit 752. The distribution of copies of content to the delivery nodes may be controlled such that throughout the CDN sufficient bandwidth for content delivery to a content consumption unit is guaranteed. In one embodiment, the CDN may relate to a CDN as described in ETSI TS 182 019.

A Consumer may use a client, a software program on the content consumption unit, to purchase content, e.g. video titles, from a CPS by sending a content request to a web portal (WP), which is configured to provide title references identifying purchasable content. In response to the content request, the client may receive at least part of the title references from the WP and location information (e.g. an URL) of a CDNCF of a CDN, which is able to deliver the selected content to the content consumption unit.

The CDNCF may send the client location information associated with one or more delivery nodes, which are configured to deliver the selected content to the client. Typically, the CDNCF may select one or more delivery nodes in the CDN, which are best suited for delivering the selected content to the client. Criteria for selecting a delivery node may include the geographical location of the client and the processing load of the delivery nodes.

A client may contact a delivery node in the CDN using various known techniques including a HTTP and/or a DNS system. Further, various streaming protocols may be used to deliver the content to the client. Such protocols may include HTTP and RTP type streaming protocols. In one embodiment an adaptive streaming protocol, such as HTTP adaptive streaming (HAS), DVB adaptive streaming, DTG adaptive streaming, MPEG DASH, ATIS adaptive streaming, IETF HTTP Live streaming and related protocols, may be used.

In the content delivery system described with reference to FIG. 7, a transaction between the CPS and a client of a content consumption unit may be established and the delivery of the content may be delegated to one or more CDNs. Delegation of content delivery to a third party increases the risk of unauthorized access. The content is therefore protected by a content protection system based on a split-key cryptosystem.

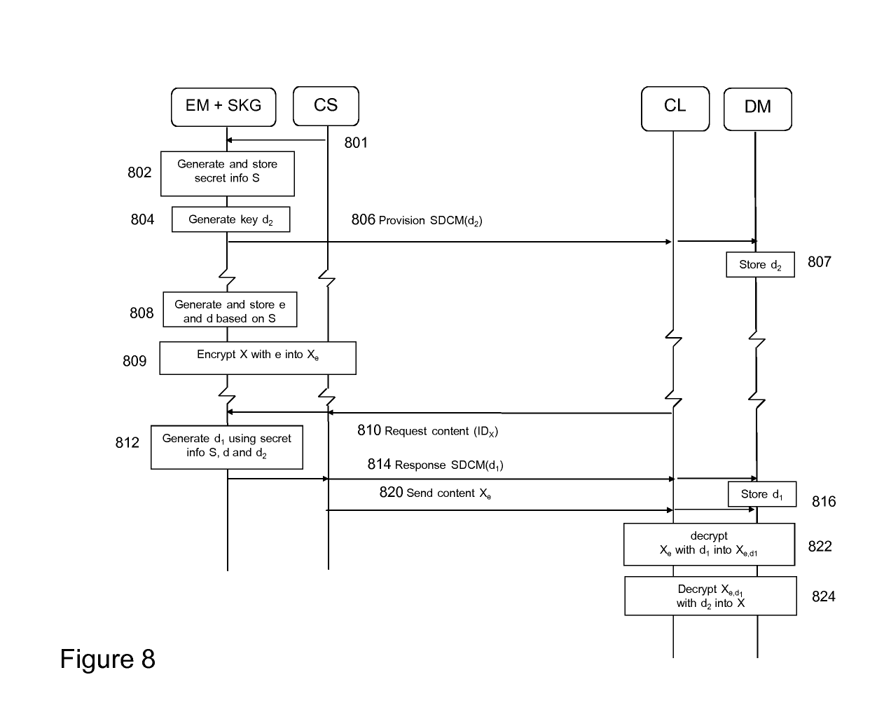

FIG. 8 depicts a schematic of a protocol flow of a content delivery system using a split-key cryptosystem according to an embodiment of the invention. In particular, FIG. 8 depicts a protocol flow for use in a secure content distribution system as depicted in FIG. 1.

The process may start with the CS triggering (step 801) the encryption module (EM), in particular the secret key generator SKG associated with the EM, to generate an secret information S. The secret information S may be associated with a particular content item X, e.g. a particular video title or stream associated with a particular content identifier ID_{X} and stored in the secure key database of the encryption module (step 802).

Thereafter, SKG may generate at least one (pseudo)random split-key d₂ on the basis of secret information S (step 804). The DM may be provisioned with d₂ using an online, off-line or over-the-air provisioning processes as described with reference to FIG. 1 (step 806). For example, in FIG. 8, split-decryption key d₂ may be sent in a split-decryption control message (SDCM) over a secure channel to the CCU. The split-decryption key d₂ is subsequently stored in a secure memory of the DM in the CCU (step 807).

Then, the SKG may generate an encryption and decryption key pair e and d on the basis of secret information S, which are stored together with S in a secure key database associated with the CS (step 808). Using encryption key e, plaintext content item X may be encrypted into encrypted content item Xₑ (step 809).

After a consumer having purchased content item ID_{X}, a client in the CCU of the consumer may send a content request to the CS (step 810). The content request may comprise the content identifier ID_{X} associated with the video title and location information, e.g. an IP address, associated with the client. The CS may relay the content request to the encryption module, which may identify the secret information S and the decryption key d in the secure key database on the basis of the content ID_{X}.

Then, on the basis of the secret information S, d and d₂, the SKG may generate a split-decryption key d₁ (step 812). The CS may send a first response message, e.g. a split-decryption control message SDCM, comprising split-decryption key d₁ and content identifier ID_{X} via a secure channel (e.g. via a key distribution network that provides end-point authentication and message encryption) to the DM in the CCU (step 814) where it may be temporarily stored in a secure memory (step 816).

The encrypted content item Xₑ may be sent to the DM of the CCU (step 820). The decryption module in the CCU partially decrypts Xₑ into X_{e,d1} using split-decryption key d₁ and subsequently partially decrypts X_{e,d1} into fully decrypted content item X using split-decryption key d₂ (step 822,824).

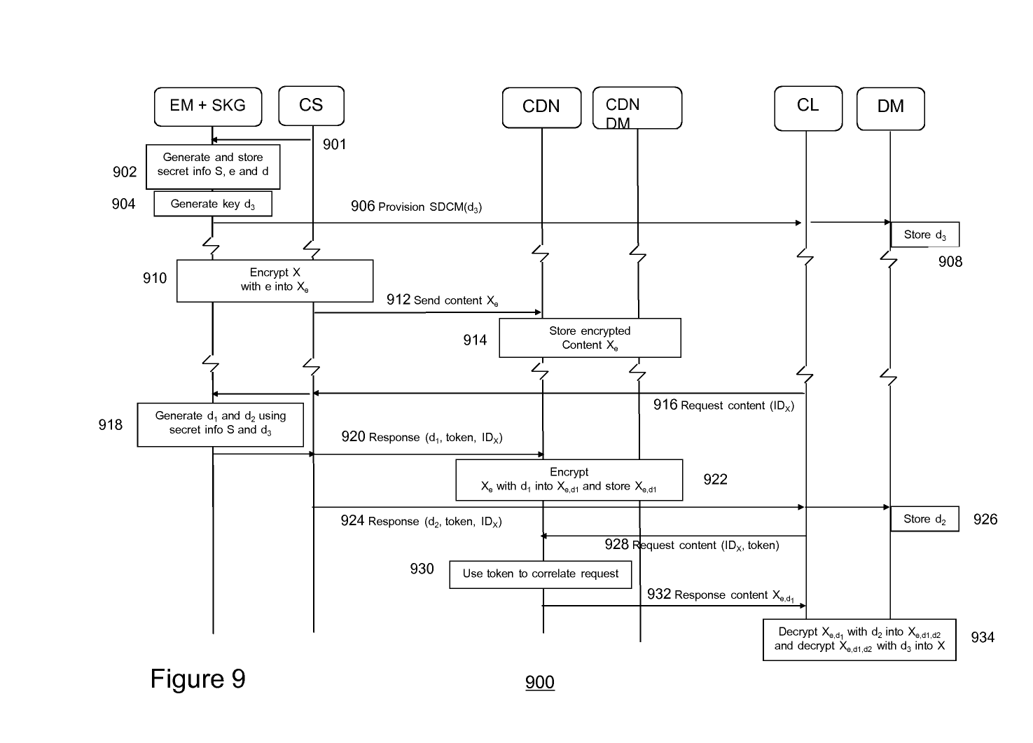

FIG. 9 depicts a schematic of protocol flow of a content delivery system using a split-key cryptosystem according to another embodiment of the invention. In particular, FIG. 9 depicts a protocol flow for use in a secure content distribution system as depicted in FIG. 5.

The process may start with the CS triggering (step 901) the encryption module (EM), in particular the SKG associated with the EM, to generate an encryption key e and a decryption key d on the basis of secret information S. The secret information S, e and d may be associated with a particular content item X, e.g. a particular video title or stream associated with a particular content identifier ID_{X} and stored in the secure key database of the encryption module (step 902).

SKG may generate split-key information, including at least one split-key d₃ on the basis of secret information S (step 904). Thereafter, the DM may be provisioned with the split-key information d₃ using an online, off-line or over-the-air provisioning processes as described with reference to FIG. 1 (step 906). For example, in FIG. 9, split-decryption key d₃ may be sent in a split-decryption control message (SDCM) over a secure channel to the CCU. The split-decryption key d₃ is subsequently stored in a secure memory of the DM in the CCU (step 908).

Then, using encryption key e, an encryption algorithm E in the EM may be used to encrypt the plaintext content item X into encrypted content item Xₑ (step 910). The encrypted content item may be ingested by the CDN (step 912), which may store the ingested encrypted content in a particular storage (step 914). Note that the ingestion process may actually be composed of several sub-steps, e.g. a trigger from the CPS to the CDN, a content-ingestion request from the CDN to the to the CPS and the actual content ingestion step again from the CPS to the CDN.

In one embodiment, the CDN control function (CDNCF) may distribute one or more copies of the encrypted content item to one or more geographically distributed delivery nodes. This way throughout the CDN sufficient bandwidth for content delivery to CCUs is guaranteed. The locations of the delivery nodes storing the encrypted content may be stored in a location database.

Then, after a consumer having purchased content item ID_{X}, a client in the CCU of the consumer may send a content request to the CPS (step 916). The content request may comprise the content identifier ID_{X} associated with the video title and location information, e.g. an IP address, associated with the client. The CS may relay the content request to the encryption module, which may identify the secret information S and the decryption key d in the secure key database on the basis of the content ID_{X}.

Then, on the basis of the secret information S and d₃, the SKG may generate further split-key information including split-decryption keys pair d₁ and d₂ (step 918). In one embodiment, the generation of the split-key pair may include the generation of a random split decryption key d₂ on the basis of secret information S and the generation of a split decryption key d₁ on the basis of the secret information S, d₂ and d₃.

Here, the split-keys may be uniquely associated with the content request using a session token, i.e. a unique identifier for identifying the content request session associated with the CCU. A token may relate to a consumer identifier, the IP address of the content consumption unit, a dedicated token or a combination thereof.

The CS may send a first response comprising first split-key information including split-decryption key d₁, the content identifier ID_{X} and the content session token (step 920) via a secure channel (e.g. via a key distribution network that provides end-point authentication and message encryption) to the CDN.

The CDN may invoke its decryption module DM via the secure interface to partially decrypt the identified encrypted content Xₑ using split-decryption key d₁ into partially decrypted content item X_{e,d1} (step 922). X_{e,d1} may be temporarily stored at a CDN content storage, or alternatively made available for relay via a CDN content streaming function in case of streaming content.

The encryption module may send a second response comprising the second split-key information including second split-decryption key d₂, the content identifier ID_{X} and the session token via a secure channel to the client in the CCU (step 924). The response may also include an identification (DNS name, IP address, etc.) of the CDN to which the client request is redirected. The client may configure the decryption module (DM) of the CCU with split-decryption key d₂ and temporarily store the content identifier ID_{X} and the content session token (step 926).

The client may send a content request including the session token and the content identifier to the identified CDN (step 928). The CDN—in response—may correlate the token with the X_{e,d1} (step 930) and has a delivery node send it to the client (step 932). In one embodiment, the CDN may redirect the client to the selected delivery node. The decryption module in the CCU then partially decrypts X_{e,d1} into X_{e, d1, d2} using split-decryption key d₂ and subsequently partially decrypts X_{e, d1, d2} into fully decrypted content item X using split-decryption key d₃ (step 928). Optionally, the decrypted content may be displayed to the consumer.

Hence, in this particular embodiment both split-keys may be processed in parallel in the sense that the partial decryption of the encrypted content Xₑ stored at the delivery node may already be started while the content request is further processed. Moreover, especially in the case of streaming content, partial decryption may typically start while encryption is still in progress. A token associated with a particular media purchase is used in the process in order to allow a scalable, secure content delivery system which allows multiple active content delivery sessions.

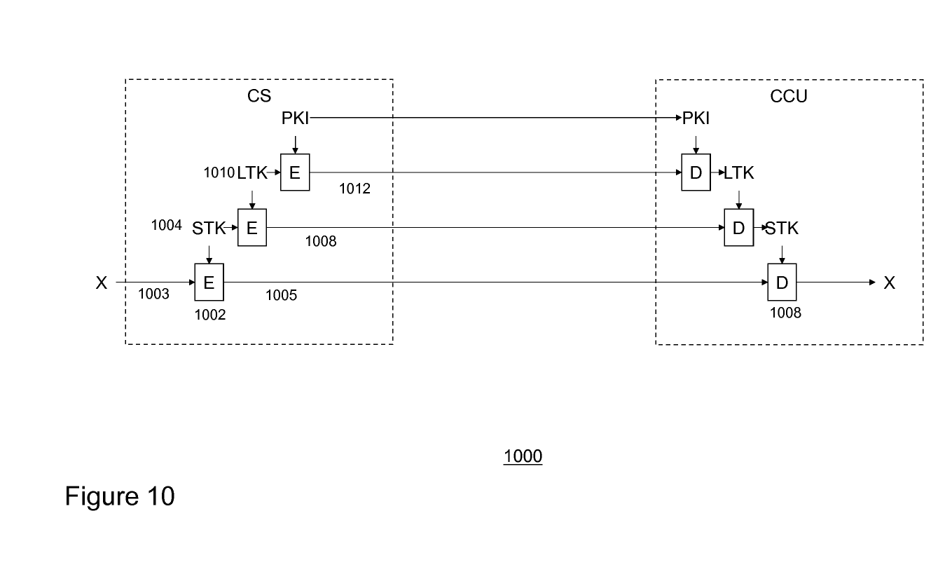

FIG. 10 depicts a schematic of a multi-layered encryption scheme. FIG. 10 depicts a conventional multi-layered (in this case four-layer) encryption system as typically used in a conditional access (CA) systems.

The first layer may relate to a CA transmitter 1002, which divides content stream X 1003 in parts, which are each encrypted (scrambled) using a symmetrical short-term key (STK) 1004 also referred to as a control word into a scrambled content stream 1005. The thus scrambled stream is transmitted to a CA receiver 1006, which is configured to descramble the scrambled stream.

The second layer may relate to the transmission of encrypted control words (also referred to as entitlement control message or ECMs), which may be sent by the CA transmitter in an ECM stream 1008 (which may be in sync with the encrypted content stream) to the CA receiver. ECMs are decrypted in the CA receiver using a long-term key 1010 (LTK) and the control words in the decrypted ECMs are used to decrypt (descramble) the encrypted content stream. The long-term key may change each month or so.

The third layer may be formed by encrypted LTKs 1012, which may be sent via a separate channel to the CA receiver. Encrypted LTKs are typically referred to as Entitlement Management Messages (EMMs).

The fourth layer may be formed by the public key infrastructure (PKI) keys, which are used to encrypt and decrypt EMMs and which are distributed via a secure module, e.g. a smart card or a SIM card, which is inserted in the CCU. The split-key cryptosystems according to the invention may be applied to any of these layers.

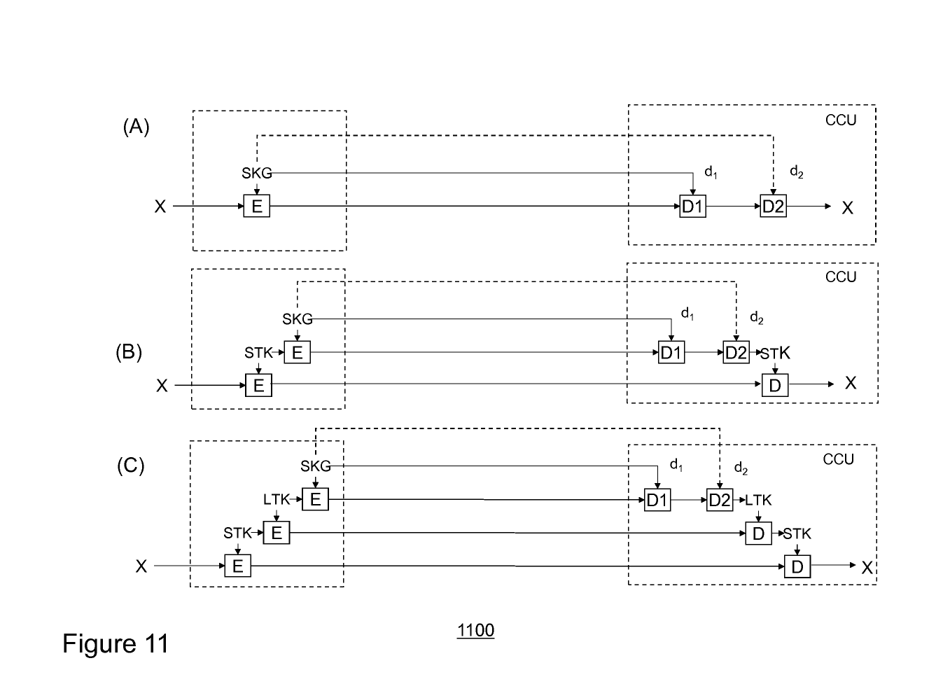

FIG. 11(A)-(C) depict various implementations of a split-key cryptosystem in a multi-layered encryption scheme wherein the CCU comprises a secure module including decryption modules which are provisioned with at least two split-keys. In one embodiment, said secure module may be pre-configured by embedding at least one split-key in a secure hardware module. The split-keys are used by decryption modules in order to decrypt an encrypted content item into plaintext. The split-keys may be provisioned in ways as described with reference to FIG. 1.

For example, FIG. 11(A) depicts an example wherein a secret key generator SKG at the transmitter side of a CA system may generate short term encryption keys (control words) for scrambling the content stream, which are sent to a first descrambling unit D1 in the CCU, which generates a partially descrambled content stream on the basis of first short term split-encryption keys {d₁} generated by the secret key generator. The thus partially descrambled content stream is subsequently forwarded to second descrambling unit D2 for fully descrambling the partially descrambled content stream on the basis of the second pre-configured split-encryption key d₂.

Similarly, FIG. 11(B) illustrates the application of the split-key cryptosystem on the level of the encryption of the control words. In this particular embodiment, the secret key generator SKG may generate an encryption key to encrypt controls words (which are used to scramble content) into ECMs. These ECMs are sent to a first decryption unit D1, which partially decrypts the stream of ECMs on the basis of first split-decryption keys {d₁} transmitted by the SKG to the first decryption unit D1. The thus generated partially decrypted ECM stream is subsequently forwarded to second decryption unit D2, which fully decrypts the partially decrypted ECMs on the basis of the second pre-configured split-decryption key d₂. The control words extracted from the decrypted ECMs are subsequently used for descrambling the scrambled content stream.

Finally, FIG. 11(C) illustrates the application of the split-key cryptosystem on the level of the encryption of the LTK into EMMs. At the transmitter side LTKs may be encrypted into EMMs and send to the first decryption unit D1 in the CCU. First decryption unit partially decrypts EMMs into partially decrypted EMMs on the basis of partial-decryption key d₁ and forwards thus partially encrypted EMMs to a second decryption unit D2, which fully decrypts the EMMs on the basis of the pre-configured second split decryption key d₂.

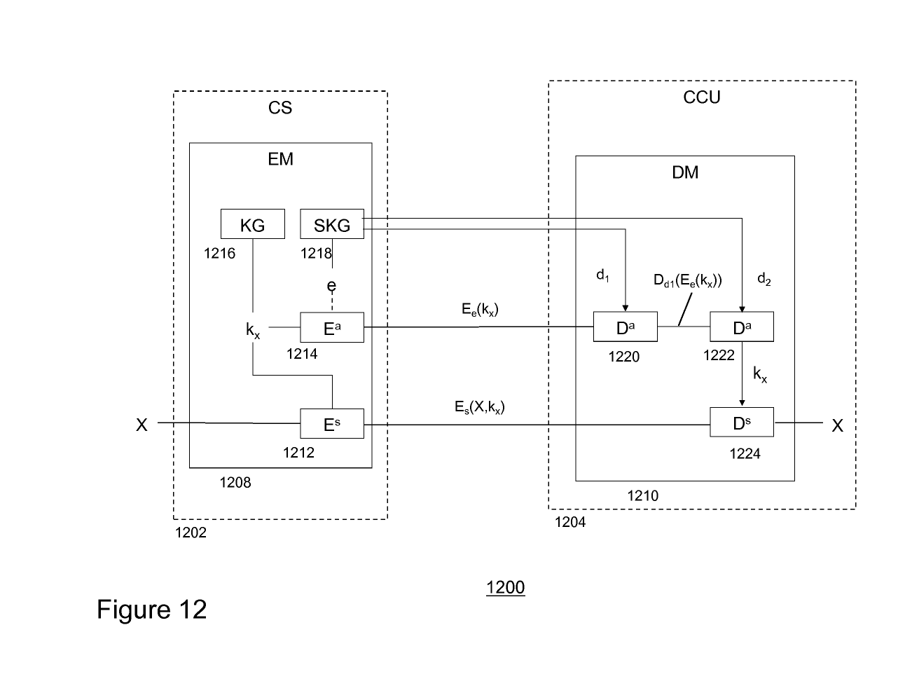

FIG. 12 depicts a hybrid split-key cryptosystem 1200 for delivering content from a CS to a CCU according to an embodiment of the invention. In particular, FIG. 12 depicts a content source CS 1202 comprising an encryption module EM 1208 comprising a symmetric encryption module 1212 associated with symmetric encryption algorithm E^{s}, asymmetric encryption module 1214 associated with asymmetric encryption algorithm E^{a}, key generator KG 1216 for generating a symmetric key and secret key generator SKG 1218.

Similarly, the CCU may comprise a decryption module DM 1210, comprising asymmetric decryption modules 1220,1222 associated with asymmetric decryption algorithm D^{a} and a symmetric decryption module 1224 associated with symmetric decryption algorithm D^{s}. Here, asymmetric encryption and decryption modules E^{a},D^{a} and the secret key generator SKG are part of an asymmetric split-key cryptosystem. The decryption module may be provisioned with split-keys d₁ and d₂ in a similar way as described with reference to FIG. 1. In particular, the decryption module may be pre-configured with a split-key d₂. Suitable asymmetric split-key cryptosystems include the RSA, EG or DJ split-decryption systems as described above.

Since asymmetric encryption ciphers are less suitable for fast encryption of content than symmetric encryption ciphers, in this embodiment the content stream X is encrypted using symmetric encryption algorithm E^{s} such as AES or a stream cipher such as RC4. A symmetric encryption key k_{X} may be generated by key generator 1216, which is used to encrypt content X on the basis of E^{s} 1212.

Encryption key k_{X} may be encrypted using an asymmetrical encryption algorithm Ea 1214 and an encryption key e generated by the secret key generator SKG.

The encrypted content E^{s}ₖₓ(X)=Eₛ(X,k_{X}) and encrypted symmetric encryption key Eₑ(k_{X}) may be subsequently transmitted to the decryption module 1210 in the CCU. The encrypted symmetric encryption key may be send to a first asymmetric encryption module Dₐ 1220 in the CCU, which partially decrypts the encrypted encryption key on the basis of a first split-key d₁ before it is forwarded to second asymmetric encryption module 1222, which is configured to fully decrypt the partially decrypted encryption key k_{X} on the basis of pre-configured split-key d₂. The thus decrypted symmetric key k_{X} may be used by symmetric encryption module 1224 to descramble the scrambled content stream.

Hybrid encryption thus allows the combination of efficient symmetric encryption of content item X and secure asymmetric encryption of symmetric encryption key k_{X} using a split-key cryptosystem. In case of streaming media, the symmetric encryption key (or secret seed) k_{X} could be changed in time on a regular basis (key roll-over).

FIGS. 13A and 13B depict split-key cryptosystems for distributing content to a content consumption unit (CCU) 1306 according to various embodiments of the invention. In particular, in these embodiments the CCU may be provisioned with multiple split-keys. FIG. 13A depicts a split-key cryptosystem comprising a content source CS 1302 comprising at least an encryption module 1308 associated with encryption algorithm E and secret key generator SKG 1310 for generating keys on the basis of secret information S. In one embodiment the SKG may be implemented according to the SKG as described with reference to FIG. 2. The key information generated by the secret key generator may include key information including at least an encryption key e and split-key information including a plurality of split-decryption keys.

The CCU 1306 may comprise a decryption module 1311, which may be implemented as a secure module, e.g. a smart card, (U)SIM or other suitable hardware-secured processor. The decryption module may be configured to execute at least a first split-decryption operation 1312 using decryption algorithm D and first split-key information comprising at least a first split-key d₁ send by the secret key generator 1310 to the decryption module.

The decryption module may further comprise a split-key processor 1314 configured to execute multiple split-key operations 1322, 1324 using decryption algorithm D and split-key information comprising multiple split-keys, in this example e.g. split-keys d_{2-geo} and d₂₋ₚₑᵣₛₒₙ. The split-key processor may select split-keys upon reception of a key identifier message 1318.

In one embodiment, the split-key processor may comprise a secure memory 1316 comprising a split-key table comprising multiple split-keys. The secure memory may be provisioned with the split-key table using an offline, online or over-the-air provisioning process as described with reference to FIG. 1 (the provisioning is schematically denoted by dashed line 1315). The split-keys in the split-key table are also known to the secret key generator. In one embodiment, the table of split-keys may be provisioned off-line on the basis of a pre-configured hardware module, e.g. a (U)SIM or smartcard.

The split-key information in the secure memory may be associated with different categories. In one embodiment, for example, one particular set of split-keys may relate to geo-specific split-keys. CCUs within one particular geographical region may be provisioned with such geo-specific split-key d_{2-geo}. In another embodiment, a particular set of split-keys may relate to content-specific split-keys. CCUs entitled to receive a particular type of content, e.g. HDTV or 3D, are provisioned with such content-specific split-key d_{2-cont}. In a further embodiment, a particular set of split-keys may relate to user-specific split-keys. For example, all CCUs associated with one user may be provided with a person-specific split-key d₂₋ₚₑᵣₛₒₙ. In another embodiment, a particular set of split-keys may relate to hardware-specific split-keys d_{2-device}. In yet another embodiment, split-key d_{2-categ} may relate to a particular category of content, e.g. sports, VoD, etc.). Such hardware-specific key may be provisioned to a specific set of devices.

Hence, in the embodiment as depicted in FIG. 13A, the secure memory in the split-key processor may be provisioned with a split-key table comprising multiple-split keys which are also known to the secret key generator associated with the CS. On the basis of a key identifier message 1318, the CS may configure the split-key processor to use a specific sequence of split-key decryption operations selected from a large set of possible split-key decryption operations as schematically illustrated by inset 1320. The number of split-key decryption operations may depend on the particular desired implementation.

The secret key generator 1310 may generate a key identifier message for signaling the CCU, which split-keys may be selected by the DM to decrypt an encrypted content item X. For example, the non-limiting example in FIG. 13A depicts a secret key generator may send a key identifier message originating from the secret key server configuring the split-key processor to perform a predetermined sequence of split-key operations on the basis of a geo-specific split-key d_{2-geo} and user-specific split-key d₂₋ₚₑᵣₛₒₙ. On the basis of these split-keys, d and S, the secret key generator may determine d₁ which is subsequently sent to the CCU in order for the decryption module to configure first split-key operation 1312.

This way, encrypted content item Xₑ originating from encryption module 1308 may first be partially decrypted on the basis of first split-key operation using first split-key d₁. Thereafter, partially encrypted content item X_{e,d1} is further decrypted on the basis of a second split-key operation and third split-key operation using geo-specific split-key d_{2-geo} and user-specific split-key d₂₋ₚₑᵣₛₒₙ respectively. In other embodiments, a sequence of more than two split-key operations may be configured.

FIG. 13B depicts a variant of the split-key cryptosystem as depicted in FIG. 13A. In this variant, the system further comprises a CDN 1304 associated with a decryption module 1313 comprising decryption algorithm D for partially decrypting encrypted content generated by the CS on the basis of split-key d₁, which may be sent by the secret key generator to the CDN. Hence, in contrast with the embodiment depicted in FIG. 13A, encrypted content Xₑ is first partially decrypted by the CDN before it is sent to the CCN, which subsequently decrypts partially decrypted content X_{e,d1} using at least two split-key decryption operations 1322,1324 as configured in the split-key processor 1314.

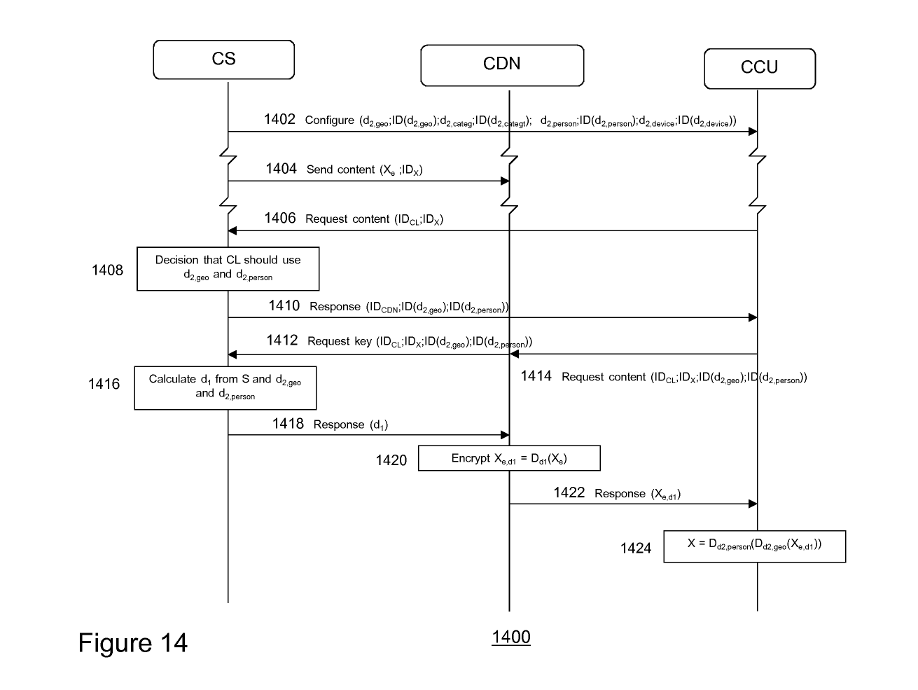

FIG. 14 depicts a flow diagram 1400 associated with a split-key cryptosystem as described with reference to FIG. 13B. The process may start with provisioning a CCU identified by a client-identifier ID_{CL} with split-key information comprising multiple split-keys (step 1402). Split-keys may be generated by the SKG on the basis of secret information S, associated with an identifier (for example d₂₋ₚₑᵣₛₒₙ, ID(d₂₋ₚₑᵣₛₒₙ); d_{2-geo}, ID(d_{2-geo}); d_{2-device}, ID(d_{2-device}); d_{2-content}, ID(d_{2-content}), etc.) and provisioned to the decryption module in the CCU. The CS may store the provisioning information associated with a particular CCU or a particular set of CCUs (i.e. secret info S, the split-keys and key identifiers, and the client-identifier) in a secure key database (not shown).

In one embodiment, the CCU may be provisioned with multiple split-keys in an off-line process. For example, a secure hardware module may be preconfigured with the split-keys and associated identifiers, during fabrication, during distribution or during activation or registration of the secure hardware modules. For example, during the purchase of a secure hardware module, the module may be configured with a number of split-keys, which are specific to the buyer. Other split-key provisioning processes, including on-line and over-the-air provisioning processes, as described for example with reference to FIG. 1 are also foreseen.

The CS may ingest encrypted content Xₑ into the CDN (step 1404). Then, the user may initiate the transmission of a first content request to the CPS (step 1406). The first content request may comprise a content identifier ID_{X} for identifying a requested content item X and ID_{CL}.

Based on the content request, the CS may decide that the decryption module in the CCU should use a particular set of split-keys for decryption, e.g. d₂₋ₚₑᵣₛₒₙ and d_{2-geo} indicating that only devices having both a predetermined personal split-key and geographical split-key may access a particular content item X (step 1408). Thereafter, in response, the CS may send a response message comprising a reference to a CDN and identifiers associated with certain split keys (in this case ID(d₂₋ₚₑᵣₛₒₙ and d_{2-geo}) (step 1410).

The CCU may use the information in the response message to send a second content request to the CDN comprising the split-key identifiers (step 1412). In response, the CDN may send a key request comprising ID_{X} and the split-key identifiers to the CS (step 1414). The CS may authorized the key request on the basis of the information in the request and the previously provisioning information in the secure key database and calculates split-key d₁ on the basis of secret key information S and the pre-configured split-keys in the CCU, in this case d₂₋ₚₑᵣₛₒₙ and d_{2-geo} (step 1416).

Split-key d₁ is then provided to CDN (step 1118), which uses this split-key to partially decrypt encrypted content item Xₑ into X_{e,d1} (step 1420). The thus partially decrypted content X_{e,d1} is sent to the decryption module of the CCU (step 1422), which may apply two subsequent split-key decryption operations, i.e. a first operation for partially decrypting X_{e,d1} into X_{e, d1, d2-person} and a second operation for partially decrypting X_{e, d1, d2-person} into X_{e, d1, d2-person,d2-geo} which equals the plain-text version of content item X (step 1424).

Hence, in this embodiment CS only needs to signal which split-keys in the table should be used during decryption. No sensitive key information needs to be sent to the CCU, thus improving security. Moreover, when using large sets of split-keys a CCU may be re-configured regularly in order to further improve security.

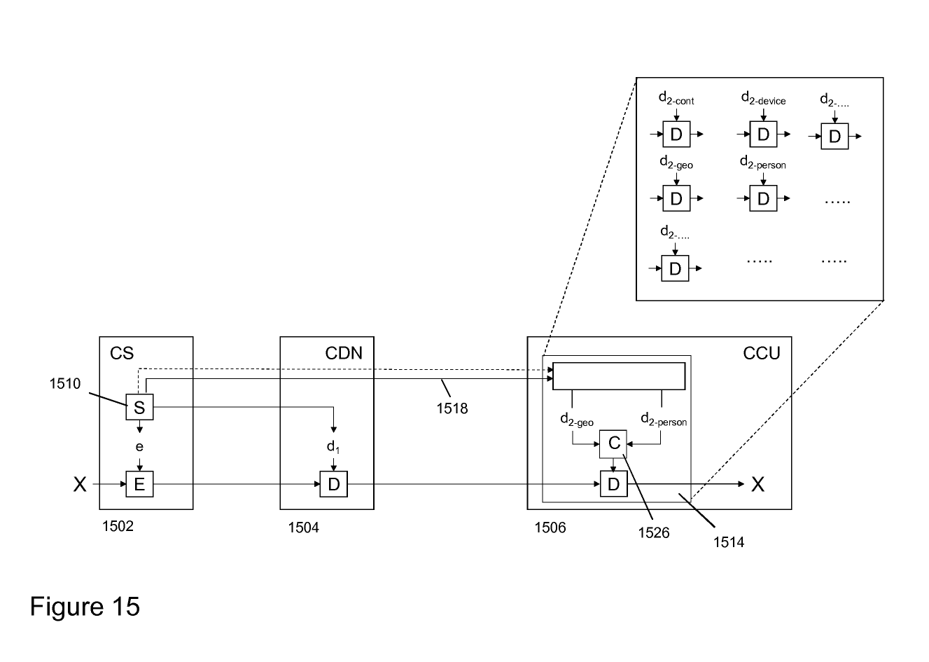

FIG. 15 depicts a split-key cryptosystem 1500 for distributing content via at least one CDN 1504 to a content consumption unit 1506 according to another embodiment of the invention. In particular, in this variant the CCU may be provisioned with multiple split-keys in a similar way as described with reference to FIGS. 13 and 14. In this particular embodiment however, the split-key processor 1514 in the CCU further comprises a combiner 1526. The combiner may comprise a processor comprising a combination algorithm C for combining split-keys selected by the split-key processor in response to a key identifier message 1518 originating from the secret key generator 1510 into a combination split-key. For example, in the example of FIG. 15 the secret key generator may have instructed the split-key processor to use a particular set of split-keys from the pre-configured set of split-keys stored in a secure memory of the split-key processor. The use of such combiner provides the advantages that less decryption steps need to be executed in the decryption module of the CCU.

The combination algorithm in the combiner may depend on the type of cipher algorithm implemented in the split-key cryptosystem. For example for the one-time-path and the stream cipher a combination function may be defined as d_{2-combi}=d_{2-geo}⊕D₂₋ₚₑᵣₛₒₙ (XOR). For the EG and the DJ encryption scheme a combination function may be defined as a simple addition: d_{2-combine}=(d_{2-combi}+d₂₋ₚₑᵣₛₒₙ)(mod p) for EG and d_{2-combi}=(d_{2-geo}+d₂₋ₚₑᵣₛₒₙ)(mod n) for DJ. For the RSA encryption scheme such combination is not possible, as splitting or combining of RSA keys requires secret information φ(n).

It is submitted that the embodiments in FIG. 13-15 are non-limiting and further embodiments are foreseen. For example, the use of a preconfigured set of split-keys as described with reference to FIG. 13-15 may also be used in a situation with no CDN as depicted in FIG. 1.

Hence, in one embodiment, the CCU in FIG. 1 may provided with a pre-configured secure hardware module, comprising multiple split-keys as described with reference to FIGS. 13 and 14. Upon a content request from the CCU, the CPS may signal the decryption module which pre-configured split-key to use. Then, on the basis of these split-keys, d₁ is calculated and directly sent to the CCU. An encrypted content item may be subsequently decrypted on the basis of d₁ and the pre-configured keys d₂₋ₚₑᵣₛₒₙ and d_{2-geo}. In a further embodiment, one or more of these split-keys may be combined to a d_{2-combi} split-key as described with reference to FIG. 15.

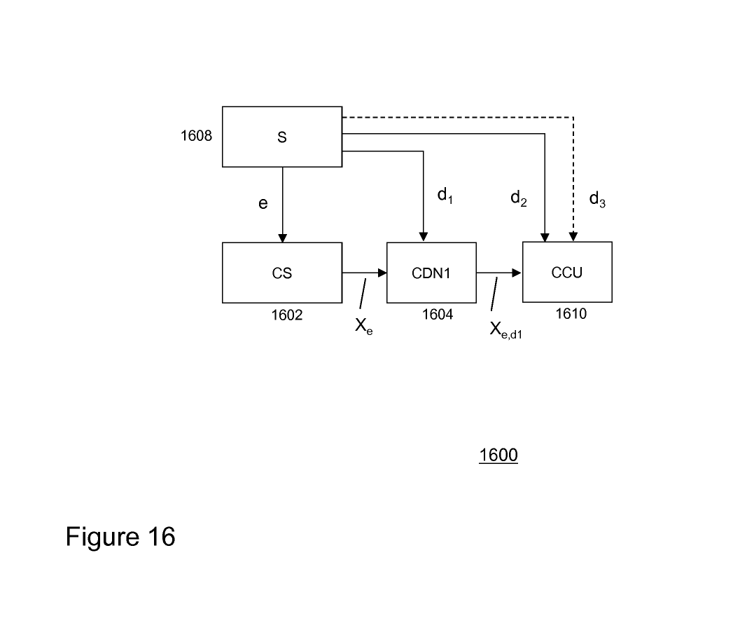

FIG. 16 depicts a secure content distribution system 1600 according to another embodiment of the invention. The content distribution system may comprise a CS 1802, one or more content distributors 1604, e.g. a CDN, a secret key server 1608 comprising the secret key generator (as e.g. described with reference to FIG. 2) and a CCU 1610.

In this particular case, the network address of the key server is different from the network address of the CS, which is used for ingesting content into CDN1. The use of a separate key server, which may be a third-party key server, is advantageous as this way the ingestion processes cannot hinder the key distribution processes. Moreover, a separate key server also provides a scalable solution as the key generation and distribution processes occur much more often than ingestion processes. Hence, when needed, two or more key servers may be assigned to one CS in order to handle the key generation and distribution processes, or conversely, one key server may serve multiple CS.

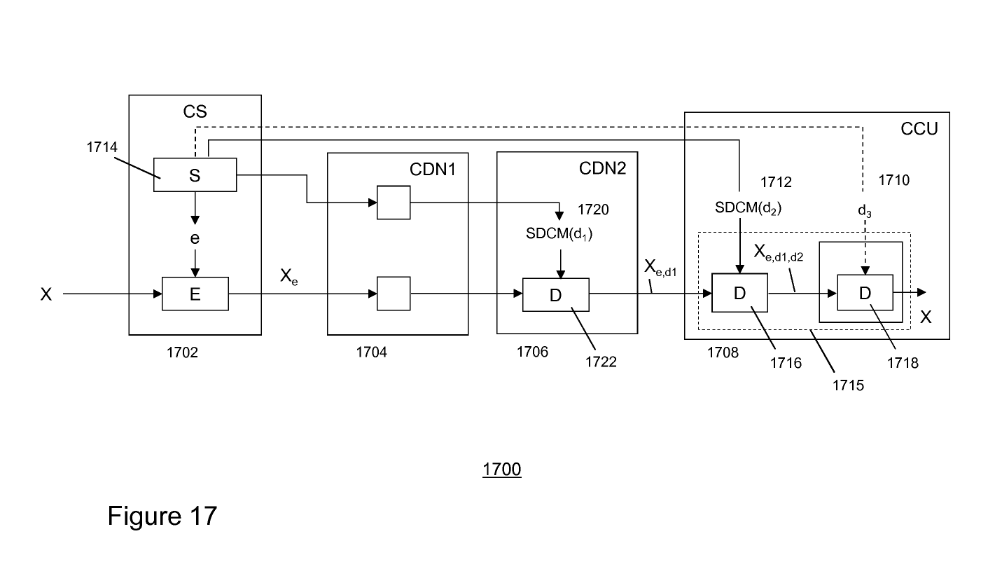

FIG. 17 depicts the use of a split-key cryptosystem in a content delivery system comprising a network CDNs according to an embodiment of the invention. In particular, in this embodiment, content originating from a CS 1702 may be securely delivered via a plurality of content distributors, i.e. least a first CDN1 1704 and second CDN2 1706, to a CUU 1708. In this embodiment, the CS may transmit encrypted content Xₑ and split-key information comprising split-key d₁ to CDN1, which may decide to outsource delivery of content to CDN2. Furthermore, the CCU may be pre-configured with split-key information comprising at least one split-key d₃ 1710. The CCU may be further configured to receive further split-key information comprising at least a further split-key d₂ 1712 from the key generator 1714 associated with the CS. Split-keys d₂ and d₃ may be used by decryption module 1715 for partially decrypting content originating from CDN2.

In contrast to the system described with reference to FIG. 6, CDN1 does not delivery partially decrypted content X_{e,d1} to CDN2. Instead, the content distribution function of CDN1 (not shown) may “transparently” relay Xₑ to CDN2. Similarly, it may relay all split-key information to further decrypt an encrypted content item X in an appropriate encryption container, in this case a split-decryption control message (SDCM) 1720, to CDN2. For example, when using an EG split-key cryptosystem the SDCM may comprise d₁=(Y₁,Y₂) and p (see table 1 for an overview the different split-key cryptosystems).

When a consumer requests content item from the CPS, split-key information comprising split-key d₂ may be sent to the CCU and split-key information comprising split-key d₁ may be sent to the decryption module 1722 of CDN2 for partially decrypting encrypted content Xₑ into partially encrypted content X_{e,d1}. The decryption module may comprise a processor which is configured to execute at least a second decryption operation 1716 on the basis of decryption algorithm D and split-key d₂ and at least a third decryption operation 1718 on the basis of decryption algorithm D and split-key d₁.

Partially decrypted content X_{e,d1} may be sent to the decryption module of the CCU, which uses split-keys d₂ and d₃ for fully decrypting partially decrypted content X_{e,d1} originating from the CDN network. Hence, in this embodiment, CDN1 screens all downstream CDNs from the CPS. This way, the CPS, and in particular the secret key generator associated with the CPS, only needs to have an interface with CDN1 and CCUs.

Various further embodiments include systems wherein the CCU may be implemented on the basis of the embodiments as described with reference to FIG. 13-15.

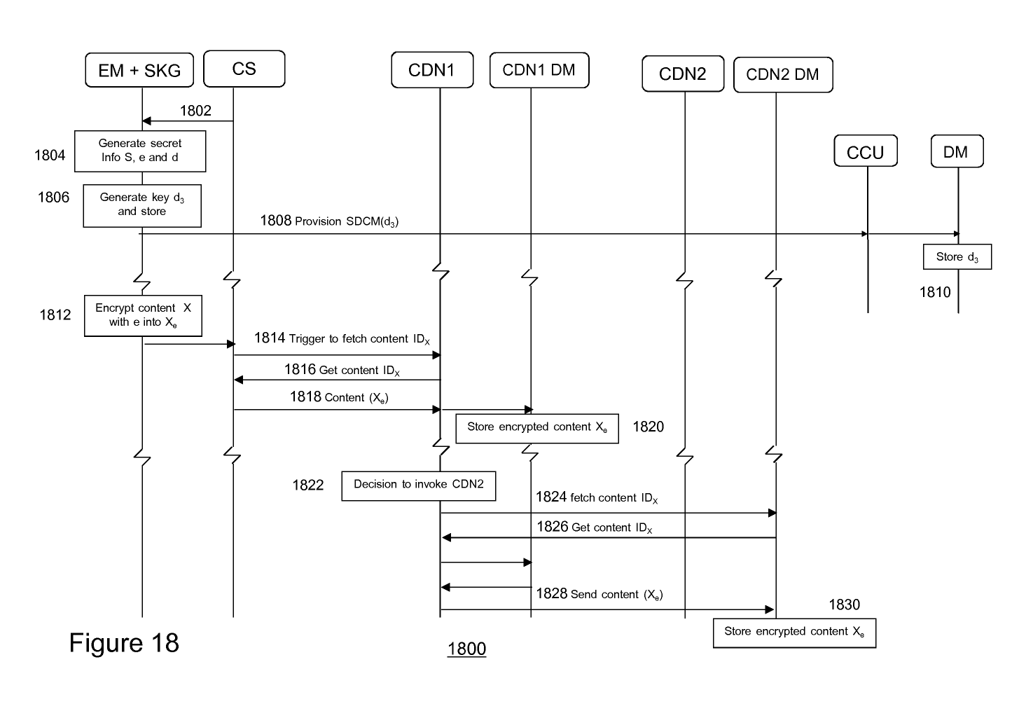

FIG. 18 depicts a schematic of protocol flow for use in a secure content delivery system as described with reference to FIG. 17 according to one embodiment of the invention. In this protocol flow content is first sent to CDN1, which subsequently forwards the content to CDN2 where it is stored for further delivery.

The process may start with the CS sending a trigger to the EM (step 1802), in particular the secret key generator associated with the EM, which in response may generate an encryption/decryption pair e,d on the basis of secret information S (step 1804). SKG may generate split-key information including random split-key d₃ on the basis of secret information S (step 1806). Decryption module in the CCU may thereafter be provisioned with split-key information including at least split-key d₃ using an online, off-line or over-the-air provisioning process as described with reference to FIG. 1 (step 1808). In the example of FIG. 18 split-key d₃ may be sent to the CCU via a secure channel in an appropriate encryption container, e.g. a Split-Key Decryption Message comprising d₃ (SDCM(d₃)) and all other (secret) information required for the particular implemented split-key cryptosystem (see table 1 for details). After the provisioning process, split-key d₃ may be stored in a secure memory of the DM in the CCU (step 1810).

Then at some point, the CS may trigger encryption module EM to encrypt content item X identified by content identifier ID_{X} into encrypted content item Xₑ (step 1812) using encryption key e. Then, the CPS may send a ingest trigger to CDN1 (step 1814) in order to start the ingestion process of content item X identified by content identifier IDₓ from the CPS into CDN1. The content ingestion process may comprise sending a content request message comprising content identifier IDₓ to the CPS (step 1816) and sending a response message comprising encrypted content item Xₑ to CDN1 (step 1818) which is subsequently stored in a storage (step 1820).

Then, at a certain moment the CDNCF of CDN1 may decide to outsource the distribution of the encrypted content Xₑ to a second content delivery network, CDN2 (the downstream CDN)(step 1822). To that end, CDN1 may send an ingestion trigger to CDN2 in order to start the process of ingesting encrypted content Xₑ into CDN2 (step 1824). The ingestion process may include a content request message comprising content identifier IDₓ (step 1826). Upon reception of the request, encrypted content is retrieved from the storage of CDN1 and sent in a response message to CDN2 (step 1828), where it is stored in a storage (step 1830).

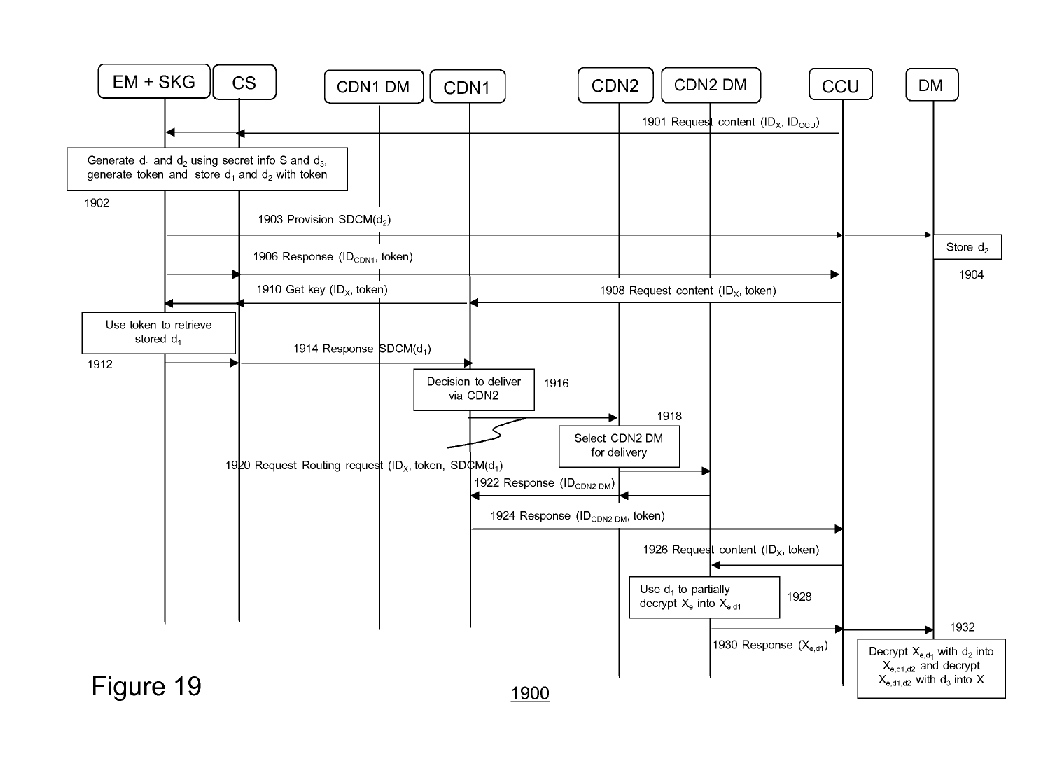

FIG. 19 depicts a schematic of a further protocol flow for a content delivery system as described with reference to FIG. 17 according to an embodiment of the invention.

The process may start with a consumer deciding to retrieve content item IDₓ. To that end, the CCU may send a first content request comprising IDₓ and an identifier for identifying ID_{CCU} to the CS (step 1901), which may forward the request to the encryption module associated with the CS.

The SKG may generate split-key information, including split-keys d₁ and d₂, on the basis of secret info S and d₃. Further, the SKG may generate a token and store d₁ and d₂ with token in a secure key database (step 1902). Split-key information comprising split-key d₂ may be sent via a secure channel in a split-decryption control message SDCM(d₃) to the CCU, where it is stored in a secure memory of the decryption module (step 1904).

In response to the request, the CS may further send a response message comprising the token and an identifier ID_{CDN1} identifying the CDN where the content item may be stored back to the CUU (step 1906). The CCU may subsequently send a second content request comprising the token and IDₓ to CDN1 (step 1908), which in response may send a key request message comprising the token and IDₓ via the CPS to the encryption module (step 1910). The token may be used to retrieve split-key d₁ (step 1912).

This split-key is sent back in split-decryption control message SDCM(d₁) to the CDN1 (step 1914) where the CDN1 may determine that the requested content item should be delivered via CDN2 (step 1916). To that end, the routing request function of CDN2 may generate a request routing message comprising IDₓ, the token and SDCM(d₁) which is sent to CDN2 (step 1918). CDN2 subsequently selects the decryption module of CDN2 (CDN2 DM) for preparing the content for delivery to the CCU (step 1920). In response, CDN2 DM may send its identifier ID_{N2-DM} to CDN1 (step 1922) which subsequently forwards ID_{N2-DM} and a token to the CCU (step 2224), such that the CCU is able to send a third content request comprising IDₓ and the token to CDN2 DM (step 1926) in order to trigger CDN2 DM to partially decrypt encrypted content Xₑ into X_{e,d1} (step 1928) and to send X_{e,d1} to the CCU (step 1930). The DM in the CCU may thereafter fully decrypt X_{e,d1} into X on the basis of d₂ and d₃ (step 1932).

Hence, in the embodiment described with reference to FIG. 17-19, the CPS only interacts with CDN1 and CDN1 outsources delivery of a content item by transparently forwarding encrypted content and a request routing message comprising the split-key information to CDN2. Furthermore, the system allows transparent delivery of a content item through the CDN network. At varies stages of the delivery process, the CS is informed and asked to take a certain action, e.g. generation and/or delivery of certain (split-)keys.

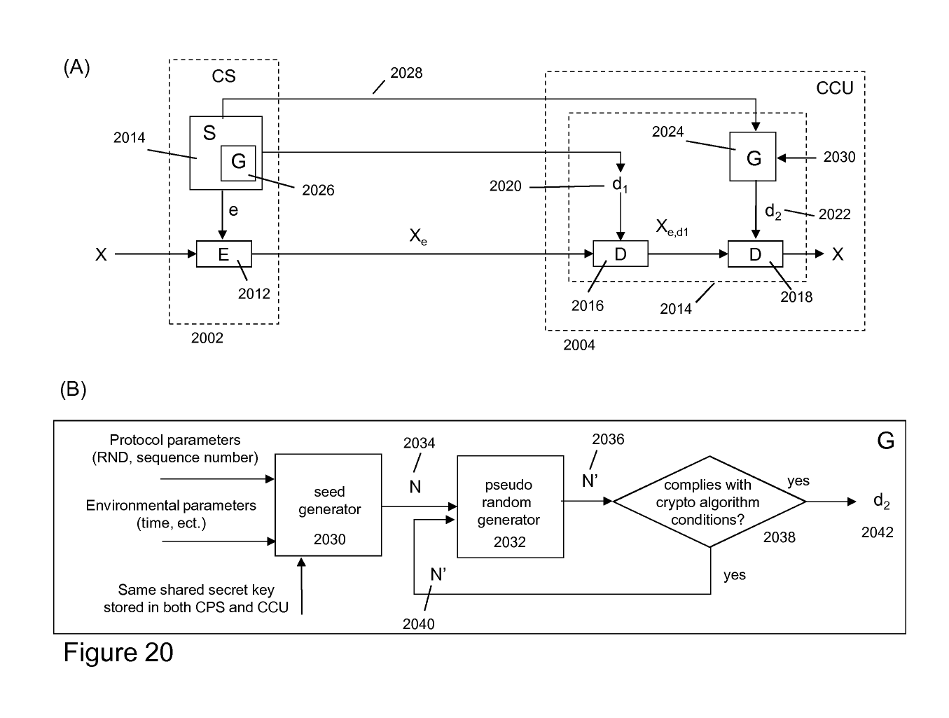

FIGS. 20 (A) and (B) depict schematics of a secure content distribution system according to another embodiment of the invention. In particular, FIG. 20 (A) depicts a CS 2002 comprising an encryption module 2012 associated with encryption algorithm E and a secret key generator 2014 for generating key information. Secret key generator 2014 may comprise a split-key generator 2026. An identical split-key generator 2026 may be implemented in or associated with a decryption module 2014 in the CCU. The decryption module may be configured to execute two or more decryption operations 2016 and 2018 respectively on the basis of decryption algorithm D and at least first and second split key information 2020 and 2022. In this particular embodiment, the first decryption operation may be based on at least a first split-key d₁ 2020 sent by the secret key generator 2014 to the CCU. The second decryption operation may based on at least a second split key d₂ 2022 generated by the split-key generator G 2024 in the decryption module.

Split-key generator G in the CCU may be configured to receive external parameters via a split-key signaling message 2028 generated by the secret key generator in the CPS. In one embodiment, the split-key signaling message may comprise an index for a table-lookup, a key identifier and/or a generated random seed. Alternatively and/or in addition, split-key generator G in the CCU may be configured to receive one or more internal parameters 2030 such as time (assuming synchronous clocks in the CPS and CCU) and/or at least a secret key.

Hence, in this particular embodiment, at least part of the split-key information is generated on the basis of two split-key generators in the key generator associated with the CPS and in the CCU respectively. In one embodiment, the key generators may comprise table of (pseudo) random keys, each identified by an index. A split-key signaling massage comprising one or more indices originating from the secret key generator may be used to generate split-key d₂.

FIG. 20(B) depicts a split-key generator G according to one embodiment of the invention. In particular, FIG. 20(B) depicts an embodiment wherein the split-key generator used in the secret key generator and the CCU is based on a pseudo-random generator. The split-key generator G may comprise a seed generator 2030 for generating a seed N 2034, which is input for a pseudo random generator 2032 for generating a random number N′ 2036 of a particular format. The split-key generator may further comprise an algorithm 2038 which checks whether the generated random number N′ complies with the conditions imposed by the particular crypto algorithm used in the split-key cryptosystem. For example, when using an RSA split-key cryptosystem, the split-key d₂ generated by the split-key generator should relate to a random integer such that 1<d₂<φ(n) and wherein d₂ and φ(n) are coprime.

Hence, the seed generator may generate a seed N on the basis of one or more parameters, including protocol parameters such as a random number generated by the CS, a sequence number, a time base common to the CS and the CCU and/or one or more secret keys stored in the CCU (and known to the CS). On the basis of the seed N, a random number N′ may be generated, which is checked by the algorithm 2038. If the generated random number N′ 2040 does not comply with the crypto algorithm conditions, it may be used as a new “seed” for generating a new random number N′. This process may be continued until a random number is generated with matches the crypto algorithm. This value is than assigned as split-key d₂ 2042.

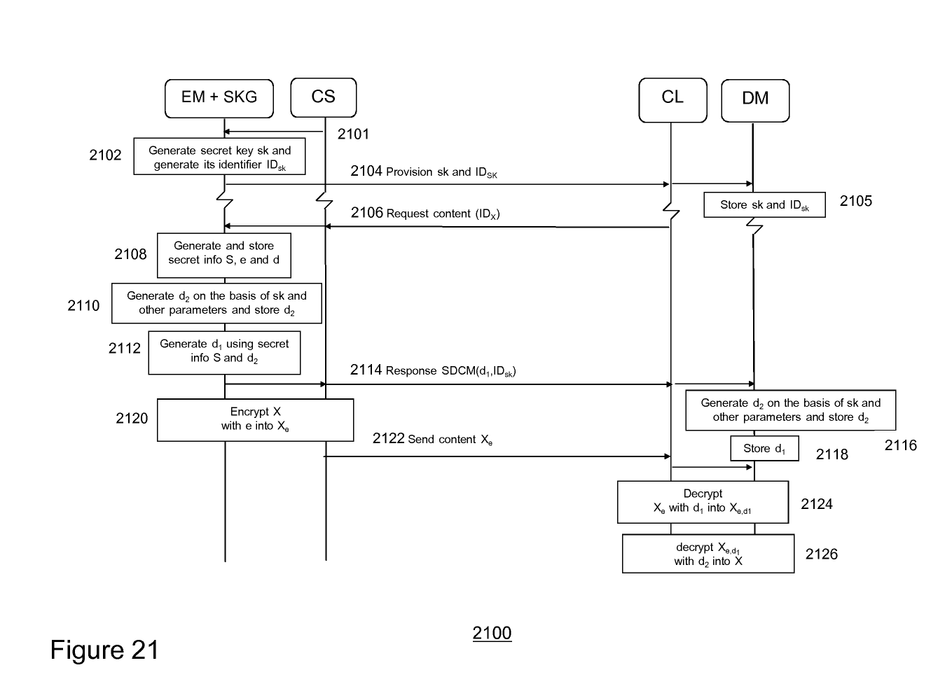

FIG. 21 depicts a schematic of a protocol flow of a content delivery system using a split-key cryptosystem according to an embodiment of the invention. In particular, FIG. 21 depicts a protocol flow for use in a secure content distribution system as depicted in FIG. 20. In this particular embodiment, the process may start with the CS sending a trigger (step 2101) to the SKG in order to generate a secret key sk and an associated identified IDₛₖ with is stored in a secure key database with the SKG. Further, decryption module of the CCU may then be provisioned with the secret key and the identifier (step 2104) and stored in a secure memory of the decryption module (step 2105). Suitable provisioning processes include those described with reference to FIG. 1.

Then, when a consumer has purchased content item ID_{X}, a client in the CCU of the consumer may send a content request to the CPS (step 2112), the CCU may send a content request comprising a content item identifier IDₓ to the CS (step 2106). The content request may comprise the content identifier ID_{X} associated with the video title and location information, e.g. an IP address, associated with the client.

In response, the CS may invoke the SKG to generate and store secret key information S and encryption and decryption keys e,d (step 2108) associated with the requested content item X identified by an identifier ID_{X}.

Further, SKG may then select secret key sk on the basis of IDₛₖ and use the sk and, optionally, other parameters as described with reference to FIG. 20 as input for split-key generator, which subsequently generates split-key information including split-key d₂, which is subsequently stored with other key information in secure key database (step 2110). On the basis of secret information S, split-key d₂ and d further split-key information comprising split-key d₁ is generated (step 2112) and sent via a secure channel (e.g. via a key distribution network that provides end-point authentication and message encryption) in a split-decryption control message, to the decryption module of the CCU wherein the message further comprises the secret key identifier IDₛₖ (step 2114). The decryption module may retrieve the secret key sk on the basis of the identifier IDₛₖ and use the secret key and, optionally other parameters, as a seed for split-key generator in order to generate split-key information comprising d₂ (step 2116), which is stored together with d₁ in a secure memory of the decryption module (step 2118).

Thereafter or in parallel to one of the steps 2110-2118 plaintext content item X may be encrypted using encryption key e into encrypted content item Xₑ (step 2120). The thus encrypted content item is then sent to the DM of the CCU (step 2122), which partially decrypts Xₑ into X_{e,d1} using split-decryption key d₁ and subsequently partially decrypts X_{e,d1} into fully decrypted content item X using split-decryption key d₂ (step 2124,2126).

It is to be understood that any feature described in relation to any one embodiment may be used alone, or in combination with other features described, and may also be used in combination with one or more features of any other of the embodiments, or any combination of any other of the embodiments. One embodiment of the invention may be implemented as a program product for use with a computer system. The program(s) of the program product define functions of the embodiments (including the methods described herein) and can be contained on a variety of computer-readable storage media. Illustrative computer-readable storage media include, but are not limited to: (i) non-writable storage media (e.g., read-only memory devices within a computer such as CD-ROM disks readable by a CD-ROM drive, flash memory, ROM chips or any type of solid-state non-volatile semiconductor memory) on which information is permanently stored; and (ii) writable storage media (e.g., floppy disks within a diskette drive or hard-disk drive or any type of solid-state random-access semiconductor memory) on which alterable information is stored. The invention is not limited to the embodiments described above, which may be varied within the scope of the accompanying claims.

1. Method for enabling secure delivery of a content item from a content source to a content receiving device, said content receiving device being associated with a decryption module and said decryption module being configured for use with a split-key cryptosystem comprising an encryption algorithm and a decryption algorithms, a cipher algorithm for generating encryption and decryption keys on the basis of secret information and a split-key algorithm for at least one of (i) splitting the encryption key into different split-encryption keys or (ii) splitting the decryption key into different split decryption keys;
the split-key cryptosystem further comprising a number of consecutive encryption and decryption operations, the method comprising:
provisioning said decryption module with first split-key information comprising at least a first split-key;
generating second split-key information comprising at least a second split-key on the basis of said first split-key information, said decryption key and, optionally, said secret information; and
provisioning said decryption module with said at least second split-key information for decrypting an encrypted content item on the basis of said first and second split-key information and the decryption algorithm in said decryption module.

2. Method according to claim 1 wherein said content source is associated with an encryption module comprising at least one encryption algorithm; and, a secret key generator, said secret key generator comprising said cipher algorithm and split-key algorithm for generating encryption key information for decrypting a content item and said at least first and second split-key information respectively.

3. Method according to claim 2 comprising:
said encryption module receiving encryption information from said secret key generator; and
said encryption module generating at least one encrypted content item on the basis of said encryption key information.

4. Method according to claim 1 wherein said decryption module is provisioned with said first and second split-key information using different split-key information provisioning methods or wherein said decryption module is provisioned with said first and second split-key information at a first point in time and a second point in time respectively.

5. Method according to claim 1 wherein provisioning said first split-key information includes:
providing said first split-key information in said decryption module during the manufacturing or distribution of said decryption module;
or, wherein provisioning said first split-key information includes:
establishing a secure channel between said content source, preferably a secret key generator associated with said content source, and said decryption module; and,
sending said at least first split-key information via said secure channel to said decryption module, preferably said secure channel being established during an authentication or registration process of said content receiving device to said content source;
or, wherein provisioning said first split-key information includes:
embedding said at least first split-key information in a secure hardware module, preferably a smart card comprising said decryption module;
or, wherein provisioning said first split-key information includes:
instructing a first split-key generator in said decryption module for generating first split-key information, preferably said first split-key generator being instructed by a signaling message originating from said content source or by a common signaling message common to said content source and said decryption module, preferably said common signaling message including a time associated with a clock which is shared between said content source and said decryption module.

6. Method according to claim 1 wherein provisioning said second split-key information includes transmitting said second split-key information to said decryption module or recording said at least second split-key information on a recording medium.

7. Method according to claim 3, further comprising:
said decryption module receiving said encrypted content item;
decrypting at least part of said encrypted content item on the basis of said first split-key information into a partially decrypted content item; and
decrypting said partially decrypted content item into a plaintext content item on the basis of said at least second split-key information.

8. Method according to claim 1 comprising:
providing an at least one content delivery network (CDN) or a network of CDNs with at least one encrypted content item;
on the basis of said first and second split-key information, said decryption key, and, optionally, said secret information, generating third split-key information;
provisioning at least one decryption module associated with said CDN or network of CDNs with said third split-key information;
generating a partially decrypted content item on the basis of said encrypted content item, a decryption algorithm in said CDN and said third-split key information; and
transmitting said partially decrypted content item to said content receiving device.

9. Method according to claim 1 wherein said at least first split-key information comprises a plurality of first split-keys and associated first split-key identifiers, hardware-specific split-keys which are valid for a particular hardware device or group of hardware device, content-specific split-keys which are valid for predetermined content item or group of content items and/or user-specific split-keys which are valid for a particular user or group of users.

10. Method according to claim 9 comprising:
providing said decryption module with information for selecting of one more split-keys; and
selecting one or more first split-keys from said plurality of first split-keys.

11. Method according to claim 5 wherein, in case of instructing a first split-key generator in said decryption module, said first split-key generator in said content receiving device comprises a pseudo random generator, said method comprising:
said split-key generator receiving information for generating a seed for said pseudo random generator;
generating a pseudo random value; and
checking whether said pseudo random value complies with one or more conditions imposed by said split-key cryptosystem for use for split-key information.

12. System for enabling secure delivery of a content item from a content source to a content receiving device, said system being configured for use with a split-key cryptosystem, said split-key crypto system comprising an encryption algorithm and a decryption algorithm, a cipher algorithm for generating encryption and decryption keys on the basis of secret information, and a split-key algorithm for at least one of (i) splitting the encryption key into different split-encryption keys or (ii) splitting the decryption key into different split encryption keys;
the split-key cryptosystem further comprising a number of consecutive encryption and decryption operations;
said system comprising:
an encryption module associated with a content source, said encryption module comprising said encryption algorithm for generating an encrypted content item;
a key generator associated with said encryption module comprising said cipher algorithm and said split-key algorithm; and
a decryption module comprising said decryption algorithm, said decryption module being associated with said content receiving device and configured for decrypting an encrypted content item on the basis of at least first and second split-key information and said decryption algorithm.

13. Key generator for use in a system according to claim 12, the key generator comprising:
a cipher generator for generating at least one of a decryption key or an encryption key on the basis of secret information; and
a split-key generator comprising a pseudo random generator for generating one or more random split-encryption keys and/or one or more random split-decryption keys respectively and a further split-key algorithm for determining a further split-encryption key on the basis of said random split-encryption keys and said encryption key or further split-decryption key on the basis of said random split-decryption keys and said decryption key.

14. Key generator according to claim 13, wherein said encryption key is encryption key e, wherein said decryption key is decryption key d, wherein said split-key algorithm for generating split keys is for generating k split keys d₁, d₂, . . . , dₖ,
wherein said encryption and decryption algorithms and said cipher algorithm are based on the ElGamal algorithm and wherein said split-key algorithm for generating k split-keys is defined as:
said random generator is configured to select k−1 random integers d₁ . . . dₖ₋₁ smaller than p;
compute final integer as dₖ=d−(d₁+ . . . +dₖ₋₁)(mod p).
or, wherein said encryption and decryption algorithms are based the Damgård-Jurik scheme E and wherein said split-key algorithm for generating k split-keys is defined as:
determine n−1 random integers d₁, . . . , dₙ₋₁ smaller than n
compute dₖ=d−(d₁+ . . . +dₙ₋₁)(mod n).
or, wherein said encryption and decryption algorithms are based the one-time pad scheme and wherein said split-key algorithm for generating k split-keys is defined as:
determine k−1 random binary streams d₁ . . . dₖ₋₁
compute dₖ=d₁⊕ . . . ⊕ dₖ₋₁⊕e.
or, wherein said encryption and decryption algorithms are based the RSA scheme and wherein said split-key algorithm for generating k split-keys is defined as:
determine k−1 random integers d1, . . . , dk−1 which are coprime with φ(n)-
compute dₖ=(d₁* . . . *dₖ₋₁)⁻¹*d(mod φ(n)).

15. A decryption module for use in, or associated with a content receiving device, said decryption module further configured for use with a split-key cryptosystem, said split-key cryptosystem comprising an encryption algorithm and a decryption algorithm, a cipher algorithm for generating an encryption key and a decryption key on the basis of secret information, and a split-key algorithm for at least one of (i) splitting the encryption key into different split-encryption keys or (ii) splitting the decryption key into different split encryption keys;
said split-key cryptosystem further comprising a number of consecutive encryption and decryption operations;
said decryption module comprising:
an input for receiving encrypted content, said content being encrypted using at least one encryption key and said encryption algorithm;
a secure storage for storing provisioned first split-key information;
an input for being provisioned with second split-key information; and
at least one processor for executing at least a first decryption operation using said second split-key information and said decryption algorithm and for executing at least a second decryption operation using said provisioned first split-key information and said decryption algorithm.

16. A recording medium comprising:
a recording area comprising data associated with a content item which is encrypted using encryption algorithm E and at least an encryption key or split-encryption key and a recording area comprising data associated with at least one split-decryption key for partially decrypting said encrypted content item using decryption algorithm D said encryption and decryption algorithm E,D being part of a split-key cryptosystem comprising encryption and decryption algorithms E and D, a cipher algorithm for generating encryption and decryption keys e,d on the basis of secret information S and a split-key algorithm for splitting e into i different split-encryption keys e₁, e₂, . . . , eᵢ and/or for splitting d into k different split-decryption keys d₁, d₂, . . . , dₖ respectively; said split-key cryptosystem further defined in that executing a number of consecutive encryption and decryption operations on content item X, applying E and split-encryption keys e₁, e₂, . . . , e, and applying D and split-decryption keys d₁, d₂, . . . , dₖ respectively, conforms to D_{dk}(D_{dk-1}( . . . (D_{d2}(D_{d1}(Eₑᵢ(Eₑᵢ₋₁( . . . (Eₑ₂(Eₑᵢ(X)) . . . ))=D_{dk}(D_{dk-1}( . . . (D_{d2}(D_{d1}(X_{e1, e2, . . . , ei}))=X wherein i,k≧1 and i+k>2.

17. A computer program product comprising software code portions configured for, when run in the memory of a computer, executing the method steps according to claim 1.

18. Method according to claim 1,
wherein said encryption and decryption algorithms are encryption and decryption algorithms E and D;
wherein said encryption and decryption keys are encryption and decryption keys e, d;
wherein generating encryption and decryption keys on the basis of secret information and a split-key algorithm for at least one of (i) splitting the encryption key into different split-encryption keys or (ii) splitting the decryption key into different split decryption keys comprises generating encryption and decryption keys e, d on the basis of secret information S and a split-key algorithm for at least one of (i) splitting e into i different split-encryption keys e₁, e₂, . . . , eᵢ or (ii) splitting d into k different split-decryption keys d₁, d₂, . . . , dₖ respectively; and
wherein the split-key cryptosystem is further defined in that executing a number of consecutive encryption and decryption operations on content item X, applying E and split-encryption keys e₁, e₂, . . . , e₁, and applying D and split-decryption keys d₁, d₂, . . . , dₖ respectively, conforms to D_{dk}(D_{dk-1}( . . . (D_{d2}(D_{d1}(Eₑᵢ(Eₑᵢ₋₁( . . . (Eₑ₂(Eₑ₁(X)) . . . ))=D_{dk}(D_{dk-1}( . . . (D_{d2}(D_{d1}(X_{e1, e2, . . . , ei}))=X wherein I,k≧1 and i+k>2.

19. Method according to claim 4, wherein said first point in time is the time wherein said decryption module is manufactured, sold or distributed to a user or registered, and said second point in time is the time that said content receiving device transmits a content request to said content source.

20. Method according to claim 6, wherein transmitting said second split-key information comprises transmitting said second split-key information over a secure channel.

21. Method according to claim 9, wherein said plurality of first split-keys comprises one or more geography-specific split-keys which are valid for a particular geographical area.

22. Method according to claim 10, wherein said information comprises one or more first key identifiers, and wherein selecting one or more first split-keys from said plurality of first split-keys comprises selecting one or more first split-keys from said plurality of first split-keys on the basis of said one or more first key identifiers.
